(19) United States
(12) Patent Application Publication
(10) Pub. No.: US 2026/0121737 A1
(43) Pub. Date: Apr. 30, 2026

(54) Spaced-Based Communication and Navigation Architecture

(71) Applicant: Blue Origin, LLC, Kent, WA (US)

(72) Inventors: Aaron ENES, Kent, WA (US); Gregor ALTVATER, Kent, WA (US)

(21) Appl. No.: 18/912,284

(22) Filed: Oct. 10, 2024

(51) Int. Cl. H04B 7/185

(52) U.S. Cl. CPC H04B 7/18513

(57) ABSTRACT

A satellite communication network can be configured to provide network operators with the ability to scale a satellite communication network quickly and efficiently without depending on suboptimal upgrades and/or additional ground stations. The satellite communication network described herein is flexible enough, providing the ability to link a variety of new, inexpensive distribution satellites to an existing network of central satellites, to meet network connectivity needs on Earth, the moon, deep-space, and/or another celestial body. A satellite communication network can include central satellites and distribution satellites. Central satellites can be physically larger in size, include sophisticated hardware and support additional functionality in comparison to distribution satellites.

### TECHNICAL FIELD

The present disclosure relates to systems and techniques for navigating and communicating in space. More specifically, the present disclosure relates to a system and architecture for communicating between satellites, spacecraft, and ground stations.

### BACKGROUND

Satellite communication in space involves the transmission of data, signals, and information between Earth-based stations, satellites orbiting a celestial body, and/or satellites in deep space. Utilizing radio frequencies, satellites receive, amplify, and retransmit signals across vast distances. These satellites operate in geostationary, medium Earth orbit, low Earth orbit, or traveling through deep space, each offering distinct advantages in coverage, latency, and bandwidth, enabling applications such as telecommunications, weather monitoring, navigation, and remote sensing.

### SUMMARY

The systems, methods, and devices described herein each have several aspects, no single one of which is solely responsible for its desirable attributes. Without limiting the scope of this disclosure, several non-limiting features will now be discussed briefly.

Described herein is an improved architecture for a satellite communication network. In some aspects, the techniques described herein relate to a device for establishing a satellite communication network, the device including: an antenna configured to communicate with a plurality of satellites; a clock configured to maintain a stable timing reference for the device; memory that stores computer-executable instructions; and a processor in communication with the memory, wherein the computer-executable instructions, when executed by the processor, cause the processor to: process a request to integrate a first satellite in the plurality of satellites into the satellite communication network; in response to the request to integrate, retrieve navigation data for the device and the first satellite and a clock signal from the clock; determine a position of the first satellite relative to the device based on the clock signal and the navigation data; generate an instruction to synchronize a second clock of the first satellite based on the clock signal; align the antenna for communication with the first satellite based on the position of the first satellite relative to the device; and transmit the navigation data, the instruction to synchronize, and the clock signal to the first satellite.

In some aspects, the techniques described herein relate to a device, wherein the clock is at least one of a cesium atomic clock, a rubidium atomic clock, a hydrogen master clock, or an optical atomic clock.

In some aspects, the techniques described herein relate to a device, wherein the navigation data includes ephemeris data, almanac data, inertial measurement data, or range data for the device, the first satellite, and the plurality of satellites.

In some aspects, the techniques described herein relate to a device, wherein the computer-executable instructions, when executed, further cause the processor to transmit a request to relay the navigation data, the instruction to synchronize, and the clock signal to the first satellite.

In some aspects, the techniques described herein relate to a device, wherein the computer-executable instructions, when executed, further cause the processor to: process a request to determine a communication schedule for transmitting the navigation data, the instruction to synchronize, and the clock signal to the first satellite and to the plurality of satellites; retrieve navigation data for the plurality of satellites; determine a communication schedule for the first satellite and the plurality of satellites based on the navigation data for the device, the first satellite, and the plurality of satellites, and the clock signal, wherein the communication schedule assigns a priority and an interval for communicating with the first satellite and the plurality of satellites; generate an instruction to synchronize the clock of the first satellite and one or more clocks of the plurality of satellites according to the clock signal; align the antenna for communication with the first satellite and the plurality of satellites according to the communication schedule; and transmit the navigation data, the instruction to synchronize, and the clock signal to the first satellite and the plurality of satellites.

In some aspects, the techniques described herein relate to a device, wherein the computer-executable instructions, when executed, further cause the processor to: process a request to interrupt the communication schedule and prioritize communication with a second satellite; cause the device to pause communication with the plurality of satellites; determine, based on the processed request, an estimated position of the second satellite; align the antenna for communication with the second satellite; and transmit the navigation data, the instruction to synchronize, and the clock signal to the second satellite.

In some aspects, the techniques described herein relate to a device, wherein the computer-executable instructions, when executed, further cause the processor to: in response to transmitting the navigation data, the instruction to synchronize, and the clock signal to the second satellite, resume communication with the plurality of satellites according to the communication schedule.

In some aspects, the techniques described herein relate to a device, further including: the antenna further including: a gimbal configured to point the antenna in a direction of the plurality of satellites, such that the plurality of satellites can receive a signal without pointing a gimbal; and a signal processor configured to modulate or demodulate a signal for communication with the plurality of satellites, such that the plurality of satellites may communicate with the device without demodulating or modulating the signal; and the clock further including: a calibration unit configured to: determine a clock drift for the clock based on a temperature or a gravitational effect; calculate a latency associated with at least one electrical circuit, wherein the latency is calculated based on a time between the clock signal at the clock and the clock signal at the antenna; and modify the clock signal based on the clock drift and the latency.

In some aspects, the techniques described herein relate to a device, wherein the computer-executable instructions, when executed, further cause the processor to: cause the gimbal to point the antenna towards the first satellite based on the position of the first satellite relative to the device; cause the calibration unit to adjust the clock signal based on a determined clock drift and a calculated latency such that the plurality of satellites can obtain a precise clock signal; and instruct the signal processor to modulate or demodulate the navigation data, the instruction to synchronize, and the clock signal such that the first satellite can operate without modulating or demodulating one or more signals.

In some aspects, the techniques described herein relate to a system for establishing a satellite communication network, the system including: a spacecraft including: an antenna configured to communicate with a plurality of satellites; a clock configured to maintain a stable timing reference for the spacecraft; memory that stores computer-executable instructions; and a processor in communication with the memory, wherein the computer-executable instructions, when executed by the processor, cause the processor to: process a request to integrate the plurality of satellites into the satellite communication network; in response to the request to integrate, retrieve navigation data for the spacecraft and the plurality of satellites, and a clock signal from the clock; determine a position of the plurality of satellites relative to the spacecraft based on the clock signal and the navigation data; generate an instruction to synchronize an onboard clock of the plurality of satellites according to the clock signal; align the antenna for communication with the plurality of satellites based on the position of the plurality of satellites relative to the spacecraft; and transmit the navigation data, the instruction to synchronize, and the clock signal to the plurality of satellites; and the plurality of satellites configured to transmit and receive communication signals from the spacecraft.

In some aspects, the techniques described herein relate to a system, wherein the clock is at least one of a cesium atomic clock, a rubidium atomic clock, a hydrogen master clock, or an optical atomic clock.

In some aspects, the techniques described herein relate to a system, wherein the navigation data includes ephemeris data, almanac data, inertial measurement data, or range data for the spacecraft and the plurality of satellites.

In some aspects, the techniques described herein relate to a system, wherein the computer-executable instructions, when executed, further cause the processor to transmit a request to relay the navigation data, the instruction to synchronize, and the clock signal to at least one other satellite in the plurality of satellites.

In some aspects, the techniques described herein relate to a system, wherein the computer-executable instructions, when executed, further cause the processor to: process a request to determine a communication schedule for transmitting the navigation data, the instruction to synchronize, and the clock signal to the plurality of satellites; determine a communication schedule for the plurality of satellites based on the navigation data and the clock signal, wherein the communication schedule assigns a priority and an interval for communications with the plurality of satellites; generate an instruction to synchronize the onboard clock of the plurality of satellites based on the clock signal; align the antenna for communication with the plurality of satellites according to the communication schedule; and transmit the navigation data, the instruction to synchronize, and the clock signal to the plurality of satellites based on the communication schedule.

In some aspects, the techniques described herein relate to a system, wherein the computer-executable instructions, when executed, further cause the processor to: process a request to interrupt the communication schedule and prioritize communication with at least one satellite in the plurality of satellites; cause the spacecraft to pause communication with the plurality of satellites; determine, based on the processed request, an estimated position of the at least one satellite; align the antenna for communication with the at least one satellite; and transmit the navigation data, the instruction to synchronize, and the clock signal to the at least one satellite.

In some aspects, the techniques described herein relate to a system, wherein the computer-executable instructions, when executed, further cause the processor to: in response to transmitting the navigation data, the instruction to synchronize, and the clock signal to the at least one satellite, resume communication with the plurality of satellites according to the communication schedule.

In some aspects, the techniques described herein relate to a system, further including: the antenna further including: a gimbal configured to point the antenna in a direction of the plurality of satellites, such that the plurality of satellites can receive a signal without pointing a gimbal; and a signal processor configured to modulate or demodulate a signal for communication with the plurality of satellites, such that the plurality of satellites may communicate with the spacecraft without demodulating or modulating the signal; and the clock further including: a calibration unit configured to: determine a clock drift for the clock based on a temperature or a gravitational effect; calculate a latency associated with at least one electrical circuit, wherein the latency is calculated based on a time between the clock signal at the clock and the clock signal at the antenna; and modify the clock signal based on the clock drift and the latency.

In some aspects, the techniques described herein relate to a system, wherein the computer-executable instructions, when executed, further cause the processor to: cause the gimbal to point the antenna towards a first satellite in the plurality of satellites based on the position of the spacecraft relative to the first satellite; cause the calibration unit to adjust the clock signal based on a determined clock drift and a calculated latency such that the plurality of satellites can obtain a precise clock signal; and instruct the signal processor to modulate or demodulate the navigation data, the instruction to synchronize, and the clock signal such that the first satellite can operate without modulating or demodulating one or more signals.

In some aspects, the techniques described herein relate to a non-transitory, computer-readable medium including computer-executable instructions for establishing a satellite communication network, wherein the computer-executable instructions, when executed by a computer system, cause the computer system to: process a request to integrate a first satellite into the satellite communication network; in response to the request to integrate, retrieve navigation data for a spacecraft and the first satellite, and a clock signal from a clock; determine a position of the first satellite relative to the spacecraft based on the clock signal and the navigation data; generate an instruction to synchronize a second clock of the first satellite based on the clock signal; align an antenna for communication with the first satellite based on the position of the first satellite relative to the spacecraft; and transmit the navigation data, the instruction to synchronize, and the clock signal to the first satellite.

In some aspects, the techniques described herein relate to a non-transitory, computer-readable medium, wherein the computer-executable instructions, when executed, further cause the computer system to: process a request to determine a communication schedule for transmitting the navigation data, the instruction to synchronize, and the clock signal to the first satellite and to a plurality of satellites; retrieve navigation data for the plurality of satellites; determine a communication schedule for the first satellite and the plurality of satellites based on the navigation data for the spacecraft, the first satellite, and the plurality of satellites, and the clock signal, wherein the communication schedule assigns a priority and an interval for communicating with the first satellite and the plurality of satellites; generate an instruction to synchronize the clock of the first satellite and one or more clocks of the plurality of satellites according to the clock signal; align the antenna for communication with the first satellite and the plurality of satellites according to the communication schedule; and transmit the navigation data, the instruction to synchronize, and the clock signal to the first satellite and the plurality of satellites. (e.g., extraterrestrial satellite communication and/or the like).

Various combinations of the above and below recited features, embodiments, implementations, and aspects are also disclosed and contemplated by the present disclosure.

Additional implementations of the disclosure are described below in reference to the appended claims, which may serve as an additional summary of the disclosure.

In various implementations, systems and/or computer systems are disclosed that include one or more computer-readable storage mediums having program instructions embodied therewith, and one or more processors configured to execute the program instructions to cause the systems and/or computer systems to perform operations comprising one or more aspects of the above- and/or below-described implementations (including one or more aspects of the appended claims).

In various implementations, computer-implemented methods are disclosed in which, by one or more processors executing program instructions, one or more aspects of the above- and/or below-described implementations (including one or more aspects of the appended claims) are implemented and/or performed.

In various implementations, computer program products comprising one or more computer-readable storage mediums are disclosed, where the computer-readable storage mediums have program instructions embodied therewith, the program instructions executable by one or more processors to cause the one or more processors to perform operations comprising one or more aspects of the above- and/or below-described implementations (including one or more aspects of the appended claims).

### BRIEF DESCRIPTION OF THE DRAWINGS

The disclosure will be understood more fully from the detailed description given below and from the accompanying figures of embodiments of the disclosure. The figures are used to provide knowledge and understanding of embodiments of the disclosure and do not limit the scope of the disclosure to these specific embodiments. Furthermore, the figures are not necessarily drawn to scale.

FIGS. 1A-1C depict schematic diagrams illustrative of satellite navigation environments in which various embodiments according to the present disclosure can be implemented.

FIG. 2 is a block diagram of an illustrative operating environment in which a communication system uses data to synchronize one or more clock signals.

FIG. 3 is a flow diagram illustrating operations performed by components of the operating environment of FIG. 2 to synchronize one or more clocks.

FIG. 4 is a flow diagram depicting an example distribution satellite integration routine.

FIG. 5 is a flow diagram depicting an example round robin communication routine.

FIG. 6 is a flow diagram depicting an example asynchronous communication routine.

### DETAILED DESCRIPTION

One of the most pressing challenges for network operators is the need for continuous and consistent communication between spacecraft, satellites, and/or ground stations. As mission objectives become more ambitious, the systems and methods employed to provide a reliable network between spacecrafts, satellites, and/or ground stations can become a critical factor for determining mission length and overall success. In a typical satellite communication network (e.g., extraterrestrial satellite communication and/or the like), each satellite communicates with a ground station to share operational data, navigation data, a precise clock signal, and/or the like. Due to several factors discussed herein, ground stations may sometimes become overwhelmed and/or unable to communicate with each satellite in a communication network. Thus, existing configurations may limit a satellite communication network's ability to scale to meet increasing demand when additional satellites are added to the satellite communication network.

As a practical example, users can Administration (NASA) experienced a communication delay while seeking to communicate with the James Webb Telescope. The delay was due in part to a scheduling conflict, where a ground station was scheduled to communicate with a group of small, inexpensive, university-owned satellites instead of with the James Webb Telescope. In addition to communication delays, this scheduling conflict resulted in higher operational costs for the James Webb Telescope program as resources were essentially on hold while waiting for an available ground station. Additionally, this scheduling conflict and communication delay had the potential to jeopardize critical scientific research resulting from data loss, reduce the telescope's efficiency if control instructions were delayed, create communication errors if clock synchronizations are prolonged, and/or impact mission timelines. Thus, to avoid scheduling conflicts and achieve a reliable satellite communication network, network operators aim to produce satellite communication systems that may be scaled without over allocating a network's limited bandwidth.

Network operators have few choices when scaling a satellite communication network's capacity to accommodate new satellites. One way to increase network capacity is to increase the number of ground stations as the number of satellites increases. New ground stations must be strategically located to maintain line-of-sight with satellites as they orbit the Earth and/or another celestial body. Unfortunately, geographic, regulatory, and/or geopolitical factors may prevent network operators from establishing new ground stations at optimal locations, thus causing dead zones and/or reduced coverage in an expanding satellite communication network. For example, establishing new ground stations may involve navigating regulatory hurdles such as obtaining permits, especially for ground stations located near sensitive environmental areas and/or near other communication systems. An ideal location for a ground station may be inaccessible and/or impractical, such as establishing a ground station over water, at the south and/or north pole, and/or in areas prone to natural disasters (hurricanes, earthquakes, and/or the like).

Additionally, cybersecurity and/or direct threats from adversaries can limit possible new locations and/or add additional costs to establishing new ground stations. Each new ground station may communicate sensitive information with satellites, making the new ground stations a target for malicious actors. With everchanging geopolitical tensions, it may be difficult for network operators to safeguard the integrity and security of each new ground station.

Another option to scale a network's capacity is to upgrade the hardware and/or software associated with existing ground stations. When upgrading existing ground stations, additional hardware and/or software must be developed, tested, and implemented. Developing and integrating new hardware and/or software into an obsolete system can become a costly and time-consuming endeavor as each existing ground station may be uniquely adapted for a desired location, requiring specialized equipment for tracking, receiving, and transmitting signals to and from additional satellites in a network. Additionally, power sources, data processing capabilities, and/or personnel associated with existing ground stations must be readily available, interchangeable, and/or trained to operate each upgraded ground station. Along with the cost of integrating hardware and/or software into existing ground stations, downtime associated with an upgrade to one ground station can add an additional burden to other ground stations within a satellite communication network. The lost capacity can either reduce connectivity and/or require complex coordination among the remaining ground stations to ensure seamless communication throughout an already busy network.

Another way to scale a satellite communication network to increase capacity involves creating alternative communication schedules to allocate time for communicating with new satellites, by for example, extending communication intervals between ground stations and existing satellites. Alternative communication schedules may be employed when a ground station is overallocated. Ultimately, if communication intervals are extended, satellites may experience delays while transmitting and/or receiving operational data, navigation data, a precise clock signal, and/or the like. In some cases, increasing a communication interval between a satellite and a ground station can delay a mission's schedule and/or cause satellites to expend excess energy while waiting for a next command.

As a specific example, a satellite may consume excess amounts of energy if the satellite does not receive a precise clock signal periodically. Each satellite includes an onboard clock that will drift over time. To minimize the impact of clock drift, a satellite's onboard clock is periodically synchronized to a precise clock signal received from a ground station. Synchronization optimizes a satellites performance, as clock signals are used to calculate maneuvers to correct an orbital trajectory, among other operations. Thus, significant clock drift can result in orbital trajectory miscalculations, impacting satellite maneuvers and/or causing an overexertion of energy. Significant clock drift can exist when communication intervals between ground stations and satellites are increased (e.g., clock synchronizations occur less frequently). Thus, satellites may inaccurately calculate and/or inefficiently execute maneuvers to correct an orbital trajectory by using an increasingly inaccurate clock signal. In some cases, inaccurate calculations may cause tracking errors and/or an overexertion of energy resulting in the complete loss of a satellite.

In some cases, network operators attempt to scale an existing network by integrating similarly equipped satellites in parallel with increasing the number of ground stations. However, there are several drawbacks to this solution that can prove costly. For example, identical satellites typically share identical hardware (e.g., power supplies, antennas, and/or the like) which may not be optimized for each satellite's specific mission. In some cases, two satellites may be manufactured with a powerful antenna although each satellite may not require such a powerful antenna. For example, a first satellite may not need as powerful of an antenna in a low earth orbit (LEO) in comparison to a second satellite in a geosynchronous orbit (GEO). In some cases, launch vehicles may not be equipped to deploy similar satellites simultaneously, as launch vehicle payloads may be limited to carrying only one or two similarly configured satellites. Thus, multiple launches may be required, which can quickly increase the cost of scaling a satellite communication network. Further, utilizing similar satellites can increase the risk of a widespread communication failure, as an inherent and/or latent manufacturing defect observed in one satellite may exist in several similar satellites. In a worst-case scenario, an inherent manufacturing defect could result in a single point failure for an entire satellite communication network, resulting in lost and/or intermittent coverage. Furthermore, innovation and flexibility within a network may suffer as each similar satellite may be incompatible with changing mission requirements and/or customer needs.

Thus, network operations seeking to quickly scale a satellite communication network desire a solution that optimizes satellite navigation and/or satellite power consumption, minimizes the risk associated with a single point failure, and improves connectivity across multiple networks without requiring additional ground stations, upgrades to existing ground stations, or adding similarly configured satellites to an existing network.

Described herein is a satellite communication network (e.g., extraterrestrial satellite communication and/or the like) configured to provide network operators with the ability to scale a satellite communication network quickly and efficiently without depending on suboptimal upgrades and/or additional ground stations. The satellite communication network described herein is flexible enough, providing the ability to link a variety of new, inexpensive distribution satellites to an existing network of central satellites, to meet network connectivity needs on Earth, the moon, deep-space, and/or another celestial body (a planet, moon, star, satellite, asteroid, comet, and/or the like).

This disclosure describes systems, components, and methods for rapidly scaling a satellite communication network using a central satellite as a relay between ground stations and a network of distribution satellites, and/or spacecraft. A communication network can include central satellites and distribution satellites. A central satellite can be physically larger in size, include sophisticated hardware and support additional functionality (e.g., to provide power for communication across vast distances, provide a precise clock signal to distribution satellites, and/or the like) in comparison to the distribution satellites. This is in contrast with a satellite communication network that involves communication between each satellite and a ground station. Thus, an advantage of the satellite communication network described herein is that one or more central satellites can perform functions associated with a ground station (e.g., communicating operational data, navigation data, a precise clock signal and/or the like), thus allowing a satellite communication network to scale while reducing and/or eliminating the need to establish and/or upgrade ground stations.

Advantageously, a satellite communication network as described herein can be rapidly scaled to meet the needs of users by adding additional central satellites and/or distribution satellites. In some examples, a launch vehicle can deploy central satellites and/or distribution satellites, such that central satellites and/or distribution satellites communicate with existing central satellites and/or distribution satellites to increase coverage and the reliability of an existing network. Alternatively and/or in addition, a launch vehicle can deploy central satellites and/or distribution satellites to establish a new communication network. Central satellites and/or distribution satellites can be positioned in a variety of similar and/or dissimilar orbits (e.g., circular orbit, elliptical orbit, geostationary orbit, geosynchronous orbit, a polar orbit, and/or the like) around the Earth, the moon, the sun, and/or another celestial body. Additionally, central satellites and/or distribution satellites can be positioned near and/or along a path between celestial bodies, to support, for example, a spacecraft's travel through deep-space.

A satellite communication network as described herein can be flexible enough to adapt to everchanging mission requirements, as distribution satellites may be compact, lighter, and more easily configured to specific mission objectives in comparison to conventional satellites discussed above. Burdensome tasks typically performed by conventional satellites, such as for example, determining location information to precisely point an antenna for communication and/or energy-intensive signal processing tasks associated with communicating with a ground station are executed by a central satellite, reducing hardware and/or software requirements for each distribution satellite. For example, a distribution satellite can maintain communication with a central satellite by using a compact, lower-powered antenna (as compared to antenna of the central satellite), because the central satellite may have a more powerful and efficient antenna (hereinafter referred to as an enhanced antenna). An enhanced antenna can be equipped with a powerful signal generator, precision gimbal, and/or sophisticated signal processing equipment to communicate within a network. An enhanced antenna can be accurately pointed towards a target via a precision gimbal, to achieve efficient communication across vast distances, while signal processing equipment can modulate and/or demodulate a signal to/from distribution satellite(s).

In contrast to an enhanced antenna, distribution satellites can include a compact, lighter, simpler, and/or more energy efficient antenna unit. An antenna unit may be an omni-directional antenna and/or an antenna array, where signals are transmitted and/or received from one or more directions simultaneously. An antenna unit may conserve power in comparison to an enhanced antenna, as some antenna units may not include capabilities to modulate and/or demodulate a signal. Although an antenna unit may provide coverage in multiple directions while consuming less power in comparison to an enhanced antenna, the antenna unit may not have the signal strength required to communicate across vast distances, from one distribution satellite to another distribution satellite. Thus, an antenna unit may have a weak signal which in turn may be received by an enhanced antenna of a central satellite.

As a result of the variations between central satellite and distribution satellite antenna configurations, distribution satellites may be relieved of signal processing tasks that involve significant amounts of energy. Because a central satellite includes, for example, an enhanced antenna, distribution satellites may have additional capacity for sensors that are helpful for mission specific objectives (e.g., surveillance, communication, scientific research and/or the like).

In contrast to conventional methods of requiring each satellite to periodically receive and synchronize an onboard clock to a ground station's precise clock signal, the satellite communication network as described herein can provide distribution satellites with a precise clock signal via central satellites. By transmitting a precise clock signal via central satellites, distribution satellites can be equipped with less sophisticated, less expensive components in comparison to central satellites, such as an onboard clock. For example, a central satellite can generate an accurate clock signal via a precise atomic clock and/or a calibration unit. The atomic clock can be a rubidium atomic clock, a cesium atomic clock, and/or another type to accurately maintain the precise time. A calibration unit may be used to measure and correct clock drift by calculating an offset and/or bias. An offset and/or bias may be generated based on a measured environmental effect that may cause a precise clock to drift, such as for example, temperature, pressure, gravitation effects, and/or other environmental factors. In some examples, a calibration unit can determine a latency associated with transmitting a precise clock signal. Latency can be based on electrical circuitry delays, communication delays, and/or the like. A calibration unit can generate an error calculation and/or correction algorithm to compensate for clock drift and/or latency. A calibration unit may include a feedback loop to continuously monitor and correct a precise clock to ensure that a central satellite may generate an accurate and precise clock signal for distribution satellite(s).

Conversely, distribution satellites can include a less sophisticated, less stable timekeeping piece. For example, a distribution satellite's clock may be an oscillator (e.g., quartz crystal oscillator, temperature-compensated crystal oscillators, and/or the like). As a result, a distribution satellite's clock may be more compact, power-efficient, and/or less expensive than a precise clock, while still providing suitable stability for communication and calculations during a mission. A distribution satellite's clock may drift at a higher rate in comparison to a precise clock, thus, it may be important to periodically synchronize a distribution satellite's clock via a precise clock signal as described herein.

Additionally, a central satellite can determine an optimized schedule for transmitting a precise clock signal to distribution satellite(s), spacecraft, another central satellite, and/or ground stations via a round robin routine as described herein, and/or asynchronously, based on a request (e.g., a distress signal and/or another signal) from distribution satellites, ground stations, central satellites, and/or a spacecraft.

In summary, a satellite communication network as described herein can allow network operations to optimize satellite navigation and/or satellite power consumption, minimize risks associated with a single point failure, and improve connectivity across multiple networks without requiring additional ground stations to quickly scale a satellite communication network.

As used herein, any antenna described herein may refer to any physical component that is capable of transmitting, receiving, or otherwise interacting with any electromagnetic signal (e.g., a radio frequency (RF) signal, an optical signal, etc.). For example, any antenna described herein may be capable of interacting with a conventional RF signal, engaging in free-space optical communications, and/or the like.

### Example Aspects Related to a Satellite Communication Environment

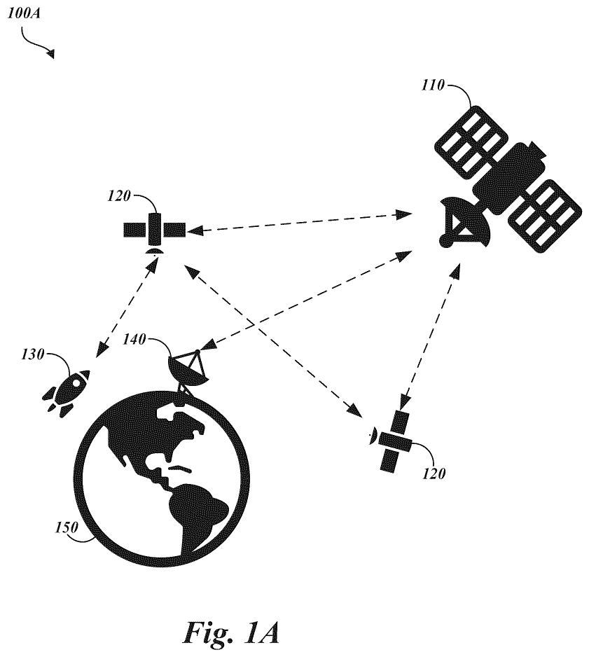

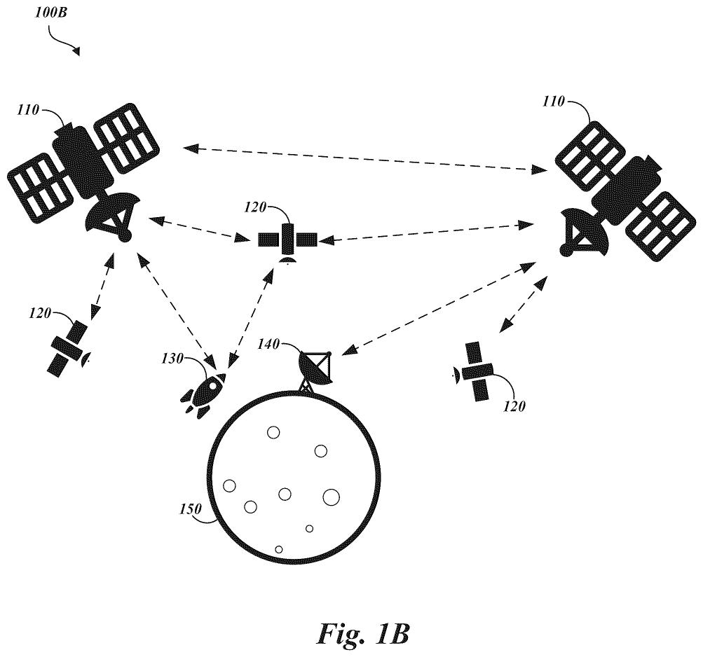

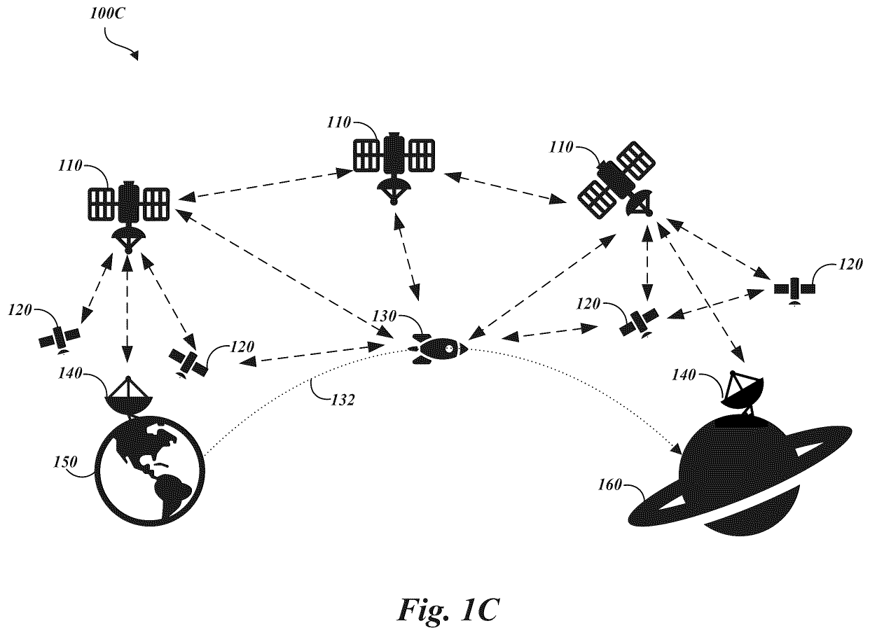

FIGS. 1A-1C depict schematic diagrams illustrative of satellite communication environments (also called satellite communication networks) 100A-100C respectively, which various embodiments according to the present disclosure can be implemented.

As illustrated in FIG. 1A, the satellite communication environment 100A may include a central satellite 110, distribution satellite(s) 120, a spacecraft 130, ground station(s) 140, and/or a celestial body 150 (e.g., Earth, a moon, another planet, an asteroid, a star, Lagrange points, other equilibrium points, and/or the like) from which or to which the central satellite 110, distribution satellite(s) 120, and/or a spacecraft 130 is traveling and/or orbiting.

A central satellite 110 can receive operational data, navigation data, a precise clock signal, and/or the like (hereinafter referred to as “data”), from ground station(s) 140 and/or generate data based on one or more components associated with the central satellite 110 as described herein. A central satellite 110 can transmit and/or receive data from distribution satellite(s) 120, a spacecraft 130, and/or ground station(s) 140. A central satellite 110 may relay data received from ground station(s) 140, to distribution satellite(s) 120 and/or spacecraft 130.

Operational data may include any information associated with one or more functions and/or a status of a central satellite 110, distribution satellite(s) 120, a spacecraft 130, and/or ground station(s) 140. For example, operational data may include, but is not limited to, telemetry data (e.g., a voltage, temperature, pressure, and/or the like), position data, speed, a health status of one or more components, power consumption data, propulsion system data (e.g., fuel remaining, fuel consumed and/or the like), payload instrument data, communication link status, thermal control system status and/or any other property of a component and/or system associated with a device or the environment with which the device operates.

Navigation data may be associated with historical, present, and/or predicted positional and/or navigational information for one or more components of satellite communication environments 100A-100C. Navigation data may include, but is not limited to, attitude and/or orientation data (e.g., yaw, pitch, and/or roll), position data (past, present, and/or future position data), orbital parameters (e.g., eccentricity, inclination, and/or the like), time synchronization data (e.g., an estimated error associated with a clock and/or the like), ephemeris data, almanac data, inertial measurement data (e.g., acceleration, angular rate, and/or the like), and/or range data (e.g., a distance between central satellite(s) 110, distribution satellite(s) 120, a spacecraft 130, and/or ground station(s) 140).

A precise clock signal may originate from a highly accurate and stable timing reference as described herein. A precise clock signal can be utilized by central satellite(s) 110, distribution satellite(s) 120, a spacecraft 130, and/or ground station(s) 140 for satellite navigation, communications, scientific experiments, and/or the like. As an illustrative example, central satellite(s) 110 may calculate ephemeris data for distribution satellite(s) 120 by utilizing a precise clocks signal. Additionally and/or optionally, central satellite(s) 110 and/or ground station(s) 140 may generate and/or transmit a precise clock signal to one or more components of a communication environment 100A-100C.

A central satellite 110 may be a device and/or space vehicle including, but not limited to, a manned and/or unmanned launch vehicle (e.g., a spacecraft, shuttle, rocket, and/or the like), space station, capsule, probe, orbiter, module, stand-alone satellite and/or the like. A central satellite 110 may be equipped with additional hardware, and/or include enhanced functionality in comparison to distribution satellite(s) 120. For example, a central satellite 110 may provide distribution satellite(s) 120 and/or a spacecraft 130 with, among other things, a precise clock signal and/or transmit a high-powered communication signal via an enhanced antenna, enabling distribution satellite(s) 120 and/or a spacecraft 130 to communicate within a satellite communication environment while utilizing less expensive (e.g., less sophisticated), lower quality hardware. In comparison to conventional methods, where each satellite must communicate with ground station(s) 140, central satellite(s) 110 deployed in one or more orbits may increase network connectivity and reliability by having a higher probability of line-of-sight to distribution satellite(s) 120 and/or spacecraft 130.

Distribution satellite(s) 120 may receive data from, and/or transmit data to central satellite(s) 110, a spacecraft 130, and/or ground station(s) 140. Distribution satellite(s) 120 may relay data from a central satellite 110 to a spacecraft 130, distribution satellite(s) 120, and/or ground station(s) 140. Additionally, distribution satellite(s) 120 may receive and synchronize an onboard clock to a precise clock signal received from a central satellite 110 and/or ground station(s) 140. Distribution satellite(s) 120 may be compact (e.g., smaller in physical dimensions), include less sophisticated hardware, and provide limited functionality in comparison to central satellite(s) 110. Distribution satellite(s) 120 may generate data associated with a communication network. For example, distribution satellite(s) 120 may generate data associated with telecommunications, navigation, observations, scientific research, remote sensing, military and defense purposes, and/or the like.

A spacecraft 130 may transmit and/or receive data from a central satellite 110, distribution satellite(s) 120, and/or ground station(s) 140. A spacecraft 130 may be any manned and/or unmanned device in orbit around a celestial body 150, traveling through space, and/or on or near the surface of a celestial body 150. For example, a spacecraft 130 may include a launch vehicle (e.g., a spacecraft, shuttle, rocket, and/or the like), terrestrial vehicle (e.g., watercraft, aircraft, handheld device, wearable device, rover, and/or the like), space station, capsule, probe, orbiter, module, interplanetary communication hub, and/or the like. In some examples, a spacecraft 130 may launch from a celestial body 150 and deploy central satellite(s) 110 and/or distribution satellite(s) 120 into one or more orbits around a celestial body 150 and/or along a trajectory. In some examples, distribution satellite(s) 120 and/or a spacecraft 130 may include the same and/or similar components and/or functionality.

Ground station(s) 140 may be any communication station associated with a celestial body 150. Ground station(s) 140 may generate data (e.g., operational data, navigation data, a precise clock signal, and/or the like) associated with the execution of a mission and/or to associated with a satellite communication network. Ground station(s) 140 may transmit data to central satellite(s) 110, to operate a communication network as described herein. Ground station(s) 140 may include several similar components and/or similar functionalities as described with reference to central satellite(s) 110 to enable communication with central satellite(s) 110 across vast distances (e.g., providing a precise clock signal, including an enhanced antenna, and/or the like).

As illustrated in FIG. 1B, a satellite communication environment 100B may include two central satellite(s) 110, a plurality of distribution satellite(s) 120, a spacecraft 130, ground station(s) 140, and/or a celestial body 150 from which or to which the central satellite 110, distribution satellite(s) 120, and/or a spacecraft 130 is traveling and/or orbiting. As depicted in FIG. 1B, a first and/or second central satellite 110 may transmit and/or receive data from ground station(s) 140. A first central satellite 110 may relay data from ground station(s) 140 to a second central satellite 110, distribution satellite(s) 120, and/or a spacecraft 130. A second central satellite 110 may relay data from a first central satellite 110, and/or generate and transmit data to distribution satellite(s) 120, a spacecraft 130, and/or ground station(s) 140.

As illustrated in FIG. 1C, a satellite communication environment 100C may include three or more central satellite(s) 110, a plurality of distribution satellite(s) 120, a spacecraft 130, a plurality of ground station(s) 140, a plurality of central bodies 150, 160 from which or two which one or more central satellite(s) 110, distribution satellite(s) 120, and/or a spacecraft 130 is traveling via path 132 and/or orbiting.

As depicted in FIG. 1C, a plurality of central satellite(s) 110 may transmit and/or receive data from a plurality of ground station(s) 140. A first central satellite 110 may relay data from a first ground station 140 to a second central satellite 110, where the second central satellite 110 may relay data to a third central satellite 110, and so on. Similar to environments 100A and 100B, central satellite(s) 110 of environment 100C can transmit data to and/or receive data from distribution satellite(s) 120, a spacecraft 130, and/or ground station(s) 140. Additionally, one or more central satellite(s) 110, distribution satellite(s) 120, and/or spacecraft 130 may be in orbit around a first celestial body 150 and/or a second celestial body 160 while one or more additional central satellite(s) 110, distribution satellite(s) 120, and/or spacecraft 130 may be in a different orbit around a first celestial body 150, a second celestial body 160, and/or along a path 132.

Advantageously, satellite communication environments 100A-100C can be scaled quickly to meet user needs, as distribution satellite(s) 120 can be integrated into an environment 100A-100C without involving communication with a ground station(s) 140. After distribution satellite(s) 120 are integrated into a network, a central satellite 110 can transmit data to and/or receive data from distribution satellite(s) 120 and/or a spacecraft 130 in a round robin fashion as described herein, to maintain connectivity and reliability throughout the satellite communication network. Additionally and/or alternatively, a central satellite 110 can interrupt a round robin routine to communicate with central satellite(s) 110, distribution satellite(s) 120, a spacecraft 130, and/or ground station(s) 140 in response to a distress signal and/or another signal requesting prioritized communication received from central satellite(s) 110, distribution satellite(s) 120, a spacecraft 130, and/or ground station(s) 140 (e.g., asynchronous communication via a distress signal and/or another signal requesting prioritized communication as described herein).

While FIGS. 1A-1C depict various satellite communication environments 100A-100C, this is not meant to be limiting. Satellite communication environments are fully configurable to meet dynamic mission and/or commercial needs. For example, a satellite communication environment can include any combination of central satellite(s) 110, distribution satellite(s) 120, spacecraft(s) 130, ground station(s) 140, and/or celestial bodies 150, 160 (e.g., 1, 2, 3, 4, 5, 6, and/or the like), in any combination of orbits (e.g., circular orbit, elliptical orbit, GEO, LEO, geosynchronous orbit, a polar orbit, L1, L2, L3, L4, L5, and/or the like), and/or in any combination of locations between one or more celestial bodies. As an illustrative example, one or more components of a satellite communication environment may be in dissimilar orbits (e.g., a central satellite 110 may be in GEO above ground station(s) 140, while a first distribution satellite 120 is in an L2 orbit, a second distribution satellite 120 is in a LEO, and so on).

### Example Aspects of an Operational Environment

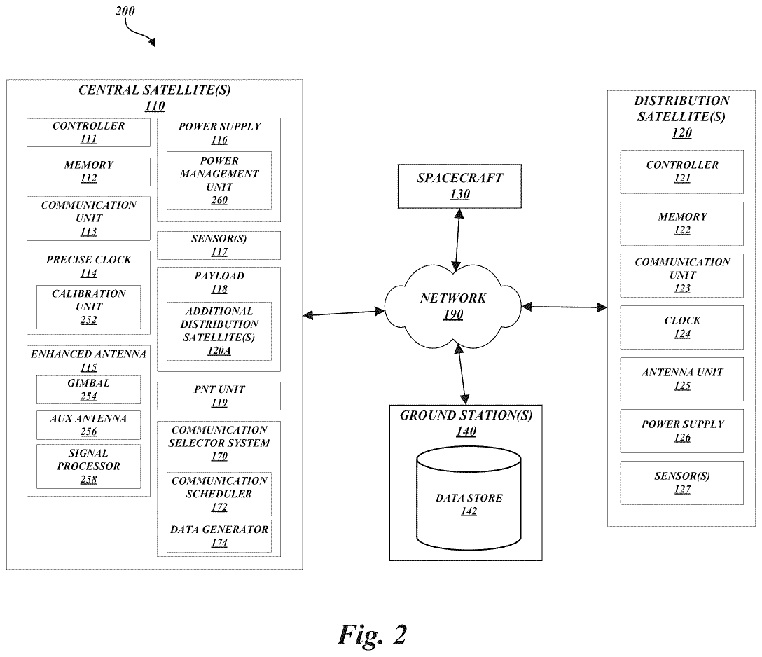

FIG. 2 is a block diagram of an illustrative operating environment 200 in which a communication selector system 170 utilizes, among other things, navigation data via data store 142 to determine a communication schedule for periodically transmitting a precise clock signal to distribution satellite(s) 120 (e.g., such that the distribution satellite(s) 120 may synchronize onboard clocks 124 for effective communication and/or navigation) from an enhanced antenna 115 of a central satellite 110. An operating environment 200 may include a spacecraft 130 that may receive navigation data, operational data, and/or a precise clock signal from central satellite(s) 110 via network 190. An operating environment 200 may include distribution satellite(s) 120, that may communicate a distress signal and/or another signal requesting prioritized communication to central satellite(s) 110 and/or instruct the central satellite 110 to stop (e.g., interrupt) a round-robin communication schedule, and asynchronously communicate with distribution satellite(s) 120 and/or execute a corrective action.

Central satellite(s) 110 may be a device and/or space vehicle including, but not limited to, a manned and/or unmanned launch vehicle (e.g., a spacecraft, shuttle, rocket, and/or the like), space station, capsule, probe, orbiter, module, and/or the like. The central satellite(s) 110 can orbit a celestial body in any number of orbits as described herein. Central satellite(s) 110 can change from one orbit to another based on an instruction received from, for example, ground station(s) 140 and/or the like. Central satellite(s) 110 may receive data (e.g., operational data, navigation data, a precise clock signal, and/or the like) from ground station(s) 140 and/or generate data based on one or more components associated with the central satellite 110 as described herein. A central satellite 110 can transmit and/or receive data from distribution satellite(s) 120, a spacecraft 130, and/or ground station(s) 140. A central satellite 110 may relay data received from ground station(s) 140, to distribution satellite(s) 120 and/or spacecraft 130.

A central satellite 110 may include various components to efficiently communicate within an operating environment 200. Central satellite(s) 110 can include a controller 111, memory 112, a communication unit 113, a precise clock 114, an enhanced antenna 115, a power supply 116, sensor(s) 117, a payload 118, and/or a PNT unit 119.

Central satellite(s) 110 can include a controller 111, memory 112, and a communication unit 113. The central satellite(s) 110 can store information obtained by the controller 111 in memory 112 (e.g., navigation data, operational data, a precise clock signal, and/or the like). The communication unit 113 can transmit and/or receive data from, for example, distribution satellite(s) 120, a spacecraft 130, ground station(s) 140, and/or the like. For example, the communication unit 113 may receive operational data, a distress signal, and/or another signal requesting prioritized communication from distribution satellite(s) 120.

The controller 111 can be any type of programmable logic controller (PLC) and/or microprocessor configured to process received commands from the communication unit 113, send and retrieve data from the memory 112, receive and calculate operating parameters, and/or energize one or more components of the central satellite(s) 110, such as the precise clock 114, enhanced antenna 115, power supply 116, sensor(s) 117, payload 118, and/or PNT unit 119. The controller 111 can receive one or more instructions to communicate, via an enhanced antenna 115, with distribution satellite(s) 120. For example, the controller 111 may, in accordance with a communication schedule received from the communication selector system 170, energize a gimbal or other antenna steering device (e.g., an electronically steerable phased array) 254 to point an enhanced antenna 115, modulate and/or demodulate a signal via signal processor 258 for transmission to and/or received from distribution satellite(s) 120, request data from sensor(s) 117, and/or store a PNT solution via PNT unit 119 as described herein. Further, the controller 111 can instruct calibration unit 252 to receive and adjust a precise timing signal from a precise clock 114 based on a calculated latency associated with one or more hardware components of the central satellite(s) 110 (e.g., a controller 111, communication unit 113, precise clock 114, enhanced antenna 115, power supply 116, PNT unit 119, and/or the like). Additionally and/or alternatively, a controller 111 can generate data, a distress signal and/or another signal requesting prioritized communication, and/or instruct a central satellite 110 to perform maneuvers to correct an orbit.

To quickly scale up and/or down a communication network, a controller 111 (e.g., as determined by communication selector system 170) may add and/or remove distribution satellite(s) 120 from a satellite communication network. For example, a controller 111 may receive a request to integrate distribution satellite(s) 120 into an existing communication network from central satellite(s) 110, distribution satellite(s) 120, a spacecraft 130, and/or ground station(s) 140. In response to receiving a request to integrate distribution satellite(s) 120, the controller 111 can transmit, to ground station(s) 140, a request for navigation data, operational data and/or the like. Optionally and/or in addition, a controller 111 may transmit a request for navigation data, operational data and/or the like, to distribution satellite(s) 120, spacecraft 130, another central satellite 110 and/or retrieve data from memory 112. Furthermore, a controller 111 can determine navigation data for distribution satellite(s) 120. As described above, navigation data can include orientation data, position data orbital parameters, time synchronization data, ephemeris data, almanac data, inertial measurement data range data, and/or the like. The controller 111 may determine navigation data for distribution satellite(s) 120 based on a precise clock signal received from the precise clock 114. In response to receiving the precise clock signal and/or the navigation data from ground station(s) 140, a controller 111 may align the enhanced antenna 115 towards distribution satellite(s) 120, and/or transmit navigation data and/or a precise clock signal to distribution satellite(s) 120. The controller 111 may receive a response from distribution satellite(s) 120, acknowledging that data was received by the distribution satellite(s) 120. In some examples, if a controller 111 does not receive an acknowledgement from distribution satellite(s) 120, the controller 111 may transmit an error message to ground station(s) 140, distribution satellite(s) 120, spacecraft 130, and/or central satellite(s) 110. Additionally, once the controller 111 receives a response from distribution satellite(s) 120, the controller 111 may integrate distribution satellite(s) 120 into a communication network.

A controller 111 may generate instructions for one or more components (e.g., an enhanced antenna 115 and/or the like) to communicate with distribution satellite(s) 120 based on, for example, a communication schedule as determined by communication selector system 170. In some cases, a controller 111 may instruct a central satellite 110 to communicate in a round robin fashion, communicating with a first distribution satellite 120, then communicating with a second distribution satellite 120, and so on. Advantageously, a controller 111 may be used to generate an optimal communication schedule for a communication network, to periodically provide a precise clock signal to distribution satellite(s) 120. As described above, the precise clock signal may enable distribution satellite(s) 120 to quickly synchronize onboard clocks, thus improving navigational efficiency and communication consistency.

A controller 111 may asynchronously communicate with central satellite(s) 110, distribution satellite(s) 120, a spacecraft 130, and/or ground station(s) 140. For example, a controller 111 may receive a distress signal and/or another signal requesting prioritized communication from distribution satellite(s) 120. A distress signal and/or another signal requesting prioritized communication may be a low-powered signal providing navigation and/or operational data (e.g., telemetry data, a status of one or more components of an operating environment and/or the like). A controller 111 may receive the distress signal and/or another signal requesting prioritized communication from an enhanced antenna 115 and/or an aux antenna 256. In some cases, the controller 111 may determine navigation data for distribution satellite(s) 120 based on a received distress signal and/or another signal that indicates a request for prioritized communication. In some cases, the controller 111 may interrupt a round robin routine to communicate with distribution satellite(s) 120 based on the received distress signal and/or another signal that indicates a request for prioritized communication. Based on the determined navigation data, a controller 111 may align an enhanced antenna 115 for optimal communication with distribution satellite(s) 120, a spacecraft 130, ground station(s) 140 and/or the like. In some cases, the controller 111 may transmit operational data, navigation data, and/or a precise clock signal to distribution satellite(s) 120 in response to a received distress signal and/or another signal requesting prioritized communication.

A controller 111 may determine a corrective action based on a received distress signal and/or another signal requesting prioritized communication. In some examples, a corrective action may include removing distribution satellite(s) 120 from a communication network, abandoning distribution satellite(s) 120, transmitting a precise clock signal and a request to synchronize to the distribution satellite 120, instructing the distribution satellite 120 to change an orbit, perform a maneuver, transmit data to another central satellite 110, distribution satellite 120, spacecraft 130, and/or ground station(s) 140, and/or the like.

The central satellite(s) 110 can include a precise clock 114. The precise clock 114 can be a highly stable timing piece. The precise clock 114 can provide a highly accurate and/or stable time reference, which is crucial for maintaining synchronization across an environment 200. The precise clock 114 may be a cesium atomic clock, rubidium atomic clock, hydrogen master clock, optical atomic clock, and/or the like. The precise clock 114 may be used by one or more components of a central satellite 110 for navigation, position information, communication, telemetry data, and/or as a timing reference for one or more components of an operating environment 200. In some examples, a precise clock 114 may drift by approximately one nanosecond per day. While in some examples a precise clock 114 may drift by more and/or less than one nanosecond per day (e.g., 0.001, 0.01, 0.1, 2, 3 and/or the like). A precise clock 114 may drift due to temperature variations, gravitational effects, and/or other environmental factors.

To mitigate clock drift, a precise clock 114 can further include a calibration unit 252. A calibration unit 252 may be a control circuit and/or part of a controller 111 and/or the like, configured to measure and correct clock drift by determining an offset and/or bias. In some examples, a calibration unit 252 may generate an offset and/or bias based on measured environmental effects that may cause a precise clock 114 to drift, such as for example, temperature, pressure, gravitation effects, and/or other environmental factors. A calibration unit 252 may calculate a latency associated with one or more components of the central satellite(s) 110 (e.g., controller 111, communication unit 113, precise clock 114, the enhanced antenna 115, a power supply 116, sensor(s) 117, payload 118, and/or PNT unit 119, and/or the like). Latency can be based on electrical circuitry delays, communication delays, and/or the like. A calibration unit 252 may generate an error calculation and/or correction algorithm to compensate for clock drift and/or latency. A calibration unit 252 may include a feedback loop, to continuously monitor and correct a precise clock 114 to ensure that a central satellite 110 may generate an accurate and precise clock signal for distribution satellite(s) 120. In some examples, a calibration unit 252 may compare a time signal generated from a precise clock 114 with a time signal received from ground station(s) 140 and/or another central satellite 110 to ensure the accuracy of a precise clock 114.

The central satellite(s) 110 can include an enhanced antenna 115. An enhanced antenna 115 can transmit to and/or receive operational data, navigation data, and/or a precise clock signal from distribution satellite(s) 120, a spacecraft 130, ground station(s) 140, and/or another central satellite 110. An enhanced antenna 115 can be for example, a directional antenna and/or another type of antenna, enabling precise alignment for optimal communication with distribution satellite(s) 120, spacecraft 130, ground station(s) 140, and/or another central satellite 110. An enhanced antenna 115 may be physically larger, have a higher gain, and/or achieve a higher signal strength to facilitate longer range communication in comparison to, for example, an antenna unit 125 as part of distribution satellite(s) 120.

The enhanced antenna 115 may include one or more components, such as a gimbal or other antenna steering device 254, an aux antenna 256, and/or a signal processor 258, to facilitate long range communication, improved network reliability, and/or efficient communication in an operating environment 200. A gimbal or other antenna steering device 254 may be used by a central satellite 110 to precisely point an enhanced antenna 115 at a target receiver (e.g., distribution satellite(s) 120, spacecraft 130, ground station(s) 140, and/or the like). A gimbal or other antenna steering device 254 may include motors, actuators, IMU's, and/or the like. In some cases, a gimbal or other antenna steering device 254 may point an enhanced antenna 115 towards a target in response to an instruction received from a controller 111, a communication scheduler 172, data generator 174, and/or the like.

An enhanced antenna 115 may include an aux antenna 256. The aux antenna 256 may be an omnidirectional antenna and/or another type of antenna, in addition to a directional antenna as described above. Additionally and/or alternatively, an aux antenna 256 may include an array of antennas configured to receive a signal from one or more directions. An aux antenna 256 may transmit and/or receive signals from one or more directions around an axis. An aux antenna 256, in comparison to the enhanced antenna 115, may have lower gain, may not achieve the same signal strength, and/or range as the enhanced antenna 115. The aux antenna 256 may be configured to receive, among other signals, a distress signal and/or another signal that indicates a request for prioritized communication from one or more directions. A distress signal and/or another signal requesting prioritized communication may be a low-powered signal indicating a status of one or more components of an operating environment 200 as described above. The aux antenna 256 may receive a distress signal and/or another signal requesting prioritized communication from distribution satellite(s) 120, spacecraft 130, and/or another central satellite 110. In some examples, an aux antenna 256 may transmit a received distress signal and/or another signal to a controller 111 as part of an asynchronous communication scheme, as described herein.

An enhanced antenna 115 may include a signal processor 258. A signal processor 258 may be a separate controller and/or part of another controller (e.g., controller 111) configured to modulate and/or demodulate a signal transmitted to and/or received from one or more components of an environment 200 (e.g., for example, distribution satellite(s) 120, and/or the like) to ensure that distribution satellite(s) 120 may communicate in an efficient manner while utilizing low power components. For example, a signal processor 258 may mix, filter, amplify, extract and/or otherwise process a transmitted and/or received signal such that distribution satellite(s) 120 may receive the signal without demodulating and/or consuming excess energy in response to the received signal.

Central satellite(s) 110 can include a power supply 116. The power supply 116 may include one or more of a combination of solar panels, batteries, radioisotope thermoelectric generators (RTGs), fuel cells, nuclear reactors, and/or the like. Power supply 116 may be physically larger, heavier, and/or have the ability to store a higher capacity of energy in comparison to power supply 126 of distribution satellite(s) 120. Power supply 116 may store excess energy to meet power demands of one or more components included in a central satellite 110. As an illustrative example, a power supply 116 may supply energy to an enhanced antenna 115 to enable frequent communications across vast distances and/or to a precise clock 114 to maintain a precise clock signal.

The power supply 116 may include a power management unit 260. The power management unit 260 can be a separate controller and/or part of one or more controllers (e.g., controller 111) used to assess, distribute, and/or conserve energy within a central satellite 110. In some examples, the power management unit 260 may determine operational schedules and/or orientations of central satellite(s) 110 to optimize solar power generation, enable battery power during eclipses and/or when sunlight is unavailable, regulate voltages and/or currents generated by the power supply 116, and/or allocate and distribute power to one or more components (e.g., an enhanced antenna 115, a precise clock 114, and/or the like).

The central satellite(s) 110 can include sensor(s) 117. Sensor(s) 117 can generate operational data for central satellite(s) 110. Sensor(s) 117 may include one or more of a combination of instruments, transducers, and/or the like, used to gather telemetry data (e.g., a voltage, temperature, pressure, and/or the like), position data, speed, a health status of one or more components, power consumption data, propulsion system data (e.g., fuel remaining, fuel consumed and/or the like), payload instrument data, communication link status, thermal control system status and/or any other property of a component and/or system associated with a device or the environment with which the device operates. In some examples, a controller 111 may request that sensor(s) 117 transmit information (e.g., a pressure, a temperature, and/or the like) to the controller 111.

The central satellite(s) 110 can include a payload 118. The payload 118 may include any cargo such, for example, additional distribution satellite(s) 120A. Additional distribution satellite(s) 120A may be similar to and/or the same as distribution satellite(s) 120. Additional distribution satellite(s) 120A may be configured to meet specific network and/or mission demands (e.g., for communication, remote sensing, scientific experiments, navigation, and/or the like). Advantageously, a central satellite 110 may be sufficiently large enough to carry and deploy additional distribution satellite(s) 120A to quickly scale a network (e.g., deploy additional distribution satellite(s) 120A into an orbit, into a plurality of orbits, and/or along a path).

Central satellite(s) 110 can include a PNT unit 119. The PNT unit 119 can execute computationally intensive tasks associated with complex algorithms to determine position, navigation, and/or timing information for central satellite(s) 110, distribution satellite(s) 120, a spacecraft 130, ground station(s) 140, a celestial body 150, 160, and/or the like. The PNT unit 119 may receive a precise clock signal from, for example, a calibration unit 252, a controller 111, a precise clock 114, communication unit 113 and/or the like. In some examples, a PNT unit 119 may be a control circuit configured to measure and/or correct clock drift. A PNT unit 119 may be a controller and/or part of a controller (e.g., controller 111). In some examples, a PNT unit 119 can determine ephemeris data for distribution satellite(s) 120. Additionally, a PNT unit 119 may generate and/or store navigation data in memory 112 and/or transmit navigation data to controller 111.

The operating environment 200 may include distribution satellite(s) 120. Distribution satellite(s) 120 may be more compact (e.g., smaller in size), lighter, consume less energy, and/or cost less to manufacture in comparison to central satellite(s) 110. Distribution satellite(s) 120 are highly configurable to meet mission and/or commercial requirements, however distribution satellite(s) 120 may include less sophisticated hardware and/or software, perform limited functions, and/or have a lower expected service life in comparison to central satellite(s) 110. In some examples, distribution satellite(s) 120 may be included in a payload 118 of central satellite(s) 110 and deployed into orbit and/or along a path as described herein. In some examples a launch vehicle (e.g., spacecraft 130) may deploy a plurality of distribution satellite(s) 120 to quickly scale a network.

Distribution satellite(s) 120 may include components to relay and/or generate data as part of a satellite communication network. Distribution satellite(s) 120 may include a controller 121, memory 122, a communication unit 123, a clock 124, an antenna unit 125, a power supply 126, and/or sensor(s) 127.

Distribution satellite(s) 120 can include a controller 121, memory 122, and a communication unit 123. The distribution satellite(s) 120 can store information obtained by the controller 121 in memory 122 (e.g., navigation data, operational data, a precise clock signal, and/or the like). The communication unit 123 can transmit and/or receive data from one or more components of an operating environment. For example, the communication unit 123 may transmit operational data and/or a distress signal and/or another signal requesting prioritized communication to central satellite(s) 110.

The controller 121 can be any type of programmable logic controller (PLC) and/or microprocessor configured to process received commands from the communication unit 123, send and retrieve data from the memory 122, receive and calculate operating parameters, and/or energize one or more components of the distribution satellite(s) 120, such as a clock 124, antenna unit 125, power supply 126, and/or sensor(s) 127. The controller 121 can receive instructions to synchronize a clock 124 based on a received precise clock signal from a central satellite 110. The controller 121 may cause distribution satellite(s) 120 to maneuver to correct an orbit and/or change an orbit based on a received data from a central satellite 110. Additionally and/or alternatively, a controller 121 can receive data from sensor(s) 127, relay data to another distribution satellite 120 received from a central satellite 110, generate a distress signal and/or another signal requesting prioritized communication, based on operational data, and/or calculate an error associated with an orbit in response to synchronizing a clock 124.

To quickly scale up and/or down a communication network, a controller 121 may transmit a request to integrate distribution satellite(s) 120 into a network. The controller 121 may transmit the request to relay an instruction to a central satellite 110 and/or another distribution satellite 120. In response to transmitting a request, a controller 121 can receive navigation data, operational data, a precise clock signal, and/or the like, from a central satellite 110. In response to receiving data, the controller 121 may determine navigation data (e.g., ephemeris data, telemetry data, and/or the like as described herein) and instruct the distribution satellite 120 to maneuver to for example, maintain an orbit. Additionally and/or optionally, a controller 121 may transmit an acknowledgement to a central satellite 110, that data was received.

In some examples, a controller 121 may transmit a distress signal and/or another signal that indicates a request for prioritized communication as described herein, if one or more components of a distribution satellite(s) 120 detects a fault and/or if the controller 121 does not receive data from a central satellite 110 when requested. As an illustrative example, a controller 121 may generate a distress signal and/or another signal if the controller 121 does not receive a precise clock signal from a central satellite 110 within a determined timeframe (e.g., according to a communication schedule).

Distribution satellite(s) 120 may include a clock 124. The clock 124 may maintain time for one or mor components of the distribution satellite 120 such as the controller 121, memory 122, communication unit 123, antenna unit 125, power supply 126, and/or sensor(s) 127. The clock 124 may be a less sophisticated, less stable timekeeping piece then, for example, a precise clock 114 as included in central satellite(s) 110. For example, a clock 124 may be an oscillator (e.g., quartz crystal oscillator, temperature-compensated crystal oscillators, and/or the like). A clock 124 may be more compact, power-efficient, and/or less expensive than a precise clock 114, but still provide suitable stability for communication and control for distribution satellite(s) 120. A clock 124 may drift at a higher rate in comparison to a precise clock 114. Because the clock 124 may drift faster than a precise clock 114, the clock 124 may be synchronized via a precise clock signal as described herein.

Distribution satellite(s) 120 may include an antenna unit 125. An antenna unit 125 may be compact, lighter, simpler, and/or more energy efficient than an enhanced antenna 115. An antenna unit 125 may be, for example, an omni-directional antenna where signals are transmitted and/or received from one or more directions simultaneously. Additionally and/or alternatively, an antenna unit 125 may be another type of antenna and/or an array of antennas. An antenna unit 125 may provide coverage in multiple directions and use less power, however, an antenna unit 125 may not have the signal strength required to communicate far distances, from one distribution satellite 120 to another distribution satellite 120. Thus, an antenna unit 125 may have a weak signal which in turn may be received by an enhanced antenna 115 of a central satellite 110. Further, an antenna unit 125 may conserve power in comparison to an enhanced antenna 115, as some antenna units 125 may not include capabilities to modulate and/or demodulate a signal (e.g., such as capabilities and functionalities discussed with reference to signal processor 258).

Distribution satellite(s) 120 may include a power supply 126. The power supply 126 may include one or more of a combination of solar panels, batteries, radioisotope thermoelectric generators (RTGs), fuel cells, nuclear reactors, and/or the like. The power supply 126 may be compact, inexpensive, and/or limited in capacity compared to a power supply 116 of a central satellite(s) 110. Power supply 126 may have a substantially lower energy capacity and/or storage requirement as, for example, an antenna unit 125 may be a lower power antenna and/or consume little to no energy to process a received signal (e.g., the received signal is fully modulated/demodulated from a central satellite 110).

Distribution satellite(s) 120 may include sensor(s) 127. Sensor(s) 127 may be similar to and/or the same as sensor(s) 117. Sensor(s) 127 can generate data for distribution satellite(s) 120. Sensor(s) 127 may include one or more of a combination of instruments and/or transducers used to gather telemetry data (e.g., a voltage, temperature, pressure, and/or the like), position data, speed, a health status of one or more components, power consumption data, propulsion system data (e.g., fuel remaining, fuel consumed and/or the like), payload instrument data, communication link status, thermal control system status and/or any other property of a component and/or system associated with a device or the environment with which the device operates. In some examples, a controller 121 may request that sensor(s) 127 transmit information (e.g., a pressure, a temperature, and/or the like) to the controller 121 and/or to another component of the environment 200. As an illustrative example, a controller 121 may receive data from sensor(s) 127, determine that a fault has occurred (e.g., a power fault, telemetry data out of range, and/or the like), and/or transmit a distress signal and/or another signal to central satellite(s) 110 based on the received data from sensor(s) 127.

The operating environment 200 may include a spacecraft 130. As mentioned above, a spacecraft 130 may transmit and/or receive data from a central satellite 110, distribution satellite(s) 120, and/or ground station(s) 140. A spacecraft 130 may be any manned and/or unmanned device in orbit around a celestial body 150, 160, traveling through space, and/or on or near the surface of a celestial body 150, 160. Additionally and/or alternatively, spacecraft 130, may include hardware and/or functionality similar to and/or the same as distribution satellite(s) 120. In some examples, more than one spacecraft 130 may be associated with an operating environment 200 (e.g., 2, 3, 4, 5 and/or more).

The operating environment 200 may include ground station(s) 140. Ground station(s) 140 may be any communication station associated with a celestial body 150, 160, and/or the like. Ground station(s) 140 may include antenna systems, transceivers, control systems, precise clocks, and/or data processing systems to facilitate the operation of a communication network. Ground station(s) 140 may transmit data (e.g., navigation data, operational data, a precise clock signal, and/or the like) to central satellite(s) 110 to enable one or more functionalities of a communication network as described herein. A ground station may be stationary and or mobile. As an illustrative example, ground station(s) 140 may transmit an instruction to central satellite(s) 110, instructing the central satellite(s) 110 to transmit a precise clock signal and an instruction to synchronize a clock to the precise clock signal to distribution satellite(s) 120.

Additionally and/or alternatively, ground station(s) 140 may include a computing system configured to store and provide access to a database of operational data, navigation data, a precise clock signal and/or the like, for one or more components of the operating environment 200. As an illustrative example, ground station(s) 140 can obtain operational data such as satellite health information and/or ephemeris data for distribution satellite(s) 120 via network 190. The ground station(s) 140 may receive and store data in, for example, data store 142.

Data store 142 may be data associated with historical data for one or more components of the environment 200. For example, data store 142 can include orbital information, ephemeris data, telemetry data, and/or any other data mentioned herein. Additionally, data store 142 can include data based on current and/or predicted positions of central satellite(s) 110, distribution satellite(s) 120, spacecraft 130, ground station(s) 140, celestial body 150, 160, and/or the like. Data stored in data store 142 may be accessed, via network 190, by the communication selector system 170 to determine a communication schedule based on, for example, data associated with distribution satellite(s) 120. While the data store 142 is depicted as being internal to ground station(s) 140, this is not meant to be limiting. For example, the data store 142 can be internal to one or more central satellite(s) 110, can be a distributed across one or more central satellite(s) 110, can be a distributed across one or more central satellite(s) 110 and one or more ground station(s) 140, and/or the like.

The communication selector system 170 can be a computing system configured to select the most optimal communication strategy (e.g., a communication schedule) between central satellite(s) 110 and distribution satellite(s) 120 in a network. For example, the communication selector system 170 can assess operational data and/or navigation data for central satellite(s) 110, distribution satellite(s) 120, a spacecraft 130, and/or ground station(s) 140, to determine an optimal communication strategy (also referred to as a round-robin communication strategy) between central satellite(s) 110, and distribution satellite(s) 120, spacecraft 130, and/or ground station(s) 140. The communication selector system 170 is depicted as a separate entity, external to, for example, central satellite(s) 110, distribution satellite(s) 120, a spacecraft 130, and/or ground station(s) 140. As an illustrative example and not meant to be limiting, a communication selector system 170 may be in electrical communication with ground station(s) 140 and transmit an optimized communication schedule to the ground station(s) 140 via a wired and/or wireless network 190. The ground station(s) 140 may then transmit the optimized communication schedule to central satellite(s) 110. Additionally and/or alternatively, the communication selector system 170 can be integrated as part of one or more components of an operating environment 200. For example, a central satellite 110, ground station(s) 140 and/or the like may include a communication selector system 170.

The communication selector system 170 may be a single computing device, or it may include multiple distinct computing devices, such as computer servers, logically or physically grouped together to collectively operate as a server system. The components of the communication selector system 170 can be implemented in application-specific hardware (e.g., a server computing device with one or more ASICs) such that no software is necessary or as a combination of hardware and software. In addition, components of the communication selector system 170 can be combined on one server computing device or separated individually or into groups on several server computing devices. In some embodiments, the communication selector system 170 may include additional or fewer components than illustrated in FIG. 2.

The communication selector system 170 can include various components, data stores, and/or the like to provide an optimal communication schedule as described herein. For example, the communication selector system 170 can include a communication scheduler 172 and/or a data generator 174.

The communication scheduler 172 can determine a schedule for communicating with distribution satellite(s) 120. The schedule can be determined based on data from ground station(s) 140 (e.g., via data store 142) and/or data generated by central satellite(s) 110. For example, a controller 111 may receive a request from a spacecraft 130, ground station(s) 140, and/or distribution satellite(s) 120, to synchronize a clock 124 to a precise clock signal. A communication scheduler 172 may receive a request to synchronize from a communication unit 113, controller 111, and/or the like. In addition to a request to synchronize a clock, the communication scheduler 172 may receive navigation data for distribution satellite(s) 120. Once the communication scheduler 172 receives both the request to synchronize and navigation data, the communication scheduler can generate an optimized schedule for transmitting a precise clock signal to distribution satellite(s) 120. An optimized communication schedule (e.g., communication schedule) can assign a priority and/or a communication interval to one or more components of an operating environment 200. An optimized communication schedule can be determined based on several considerations, such as but not limited to, the availability of line-of-sight, time since last transmission and/or last synchronization, operational windows (e.g., whether the distribution satellite 120 is in an operational state and capable of receiving data), efficient power transmissions (e.g., determining when to point an enhanced antenna 115 to obtain efficient energy consumption), whether central satellite(s) 110 should transmit a precise clock signal, anticipated future satellite communications, existence of mission critical events (e.g., launch, landing, transfer from one orbit to another, number of distribution satellite(s) 120 in a network, and/or the like.

The communication scheduler 172 may transmit a request to synchronize distribution satellite(s) 120 and/or a generated communication schedule to the data generator 174. The data generator 174 may also receive a precise clock signal from a precise clock 114 as described herein. The data generator 174 may generate instructions to align an enhanced antenna 115 with distribution satellite(s) 120, and/or instructions for distribution satellite(s) 120 to synchronize a clock 124 to the precise clock signal. Instructions created by data generator 174 may include alignment information, directing controller 111 to position a gimbal or other antenna steering device 254 in a specific direction at a specific time for efficient communication with distribution satellite(s) 120. Further, the instructions may request that a signal processor 258 modulate and/or demodulate synchronization instructions for distribution satellite(s) 120, such that the distribution satellite(s) 120 may conserve energy while receiving the precise clock signal and instructions to synchronize. The data generator 174 may transmit, via network 190, the instructions to synchronize, the instructions to align, and/or the precise clock signal, to the central satellite(s) 110.

The network 190 may include any wireless network. For example, the network 190 may be a geostationary, medium earth orbit, and/or low earth orbit satellite network, a satellite constellation, a military satellite network, a broadcast satellite network, a Global Navigation Satellite System (GNSS), a polar orbit satellite network, and/or the like. As a further example, the network 190 may be a publicly accessible network of linked networks, possibly operated by various distinct parties. In some embodiments, the network 190 may be a private or semi-private network, such as a military, a corporate, and/or a university network. The network 190 can use protocols and components for communicating via central satellite(s) 110, distribution satellite(s) 120, a spacecraft 130, and/or ground station(s) 140, and/or the like. For example, the protocols used by the network 190 may include Consultive Committee for Space Data Systems protocols (CCSDS), Digital Video Broadcasting (DVB) protocols, Transmission Control Protocol/Internet Protocol (TCP/IP), Time Division Multiple Access (TDMA), Code Division Multiple Access (CDMA), and/or the like. Protocols and components for communicating via a network 190 and/or any of the other aforementioned types of communication networks are well known to those skilled in the art and, thus, are not described in more detail herein.

### Example Block Diagram for Synchronizing a Distribution Satellite to a Precise Clock Signal

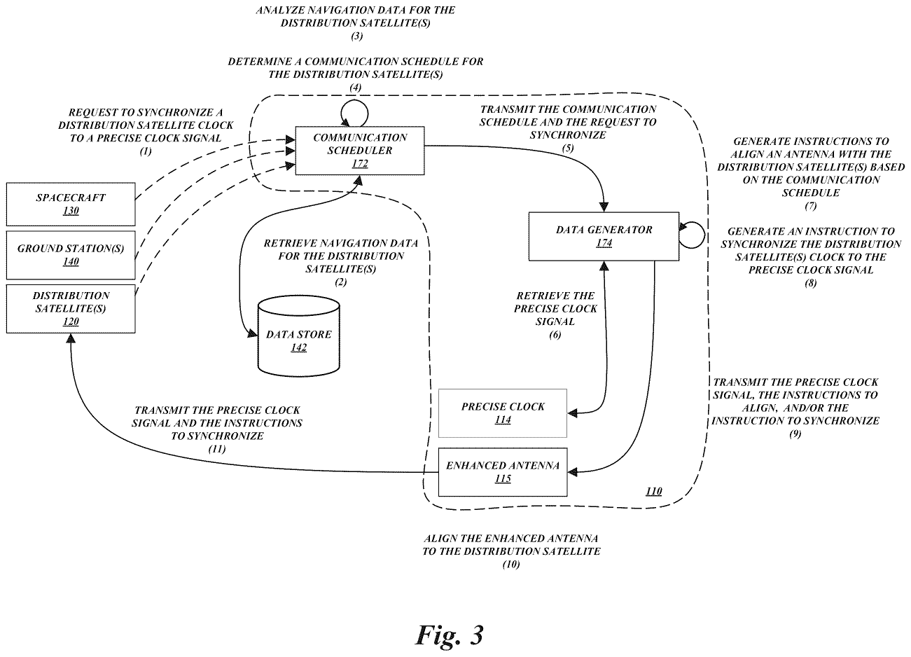

FIG. 3 is a flow diagram illustrating operations performed by the components of operating environment 200 of FIG. 2 to determine a communication schedule for a network of distribution satellite(s) 120 such that central satellite(s) 110 may transmit, among other things, a precise clock signal to distribution satellite(s) 120.

As illustrated in FIG. 3, either a spacecraft 130, ground station(s) 140, and/or distribution satellite(s) 120 transmit a request to synchronize a distribution satellite 120 clock to a precise clock signal at (1). The request can be transmitted to a communication scheduler 172. The request to synchronize may be transmitted in response to a calculated error associated with a clock 124 of a distribution satellite 120, a spacecraft 130, and/or determined by central satellite(s) 110 and/or ground station(s) 140. In some examples, a request to synchronize may be transmitted to a communication scheduler 172 in response to a request to integrate distribution satellite(s) 120 into a communication network (e.g., an operating environment 200 of FIG. 2). Additionally, a request to synchronize may be transmitted from central satellite(s) 110 to a communication scheduler 172 based on a round robin routine and/or asynchronously as described below. In some examples, a request to synchronize may be relayed from one or more components of an operating environment 200 to the communication scheduler 172. For example, a first distribution satellite 120 may generate a request to synchronize a clock 124 of the first distribution satellite 120. The first distribution satellite 120 may transmit the request to a second distribution satellite 120. In response, the second distribution satellite 120 may relay the request to a communication scheduler 172.

As mentioned herein, a distribution satellite 120 may include a less accurate clock 124 in comparison to a precise clock 114 utilized by central satellite(s) 110. Thus, clock 124 may drift substantially in comparison to a precise clock 114 over time. To minimize the impact of clock drift while utilizing a less expensive and more compact clock 124, distribution satellite(s) 120 periodically synchronize the clock 124 to a precise clock signal received from a precise clock 114. Periodically synchronizing the clock 124 to a precise clock 114 (e.g., to correct clock drift) can optimize several operations performed by distribution satellite(s) 120, such as increase the accuracy of calculated maneuvers, optimize fuel consumption while executing maneuvers, and/or the like. If a clock 124 is not periodically synchronized, an error associated with clock drift may result in significant miscalculations, causing distribution satellite(s) 120 to stray from an expected orbit and/or path, compromise network connectivity, require additional energy to correct a trajectory, and/or render distribution satellite(s) 120 inoperable.

Once a request to synchronize is received by the communication scheduler 172, the communication scheduler 172 may retrieve navigation data for the distribution satellite(s) 120 at (2). Navigation data may be retrieved from a data store 142. Data store 142 may be part of ground station(s) 140. In some examples, navigation data may be retrieved from memory 112, 122, and/or another component of the operating environment 200 of FIG. 2. Navigation data can include, but is not limited to, historical, present, and/or predicted attitude and/or orientation data (e.g., yaw, pitch, and/or roll), position data (e.g., past, present, and/or future position data), orbital parameters (e.g., eccentricity, inclination, and/or the like), time synchronization data (e.g., an estimated error associated with a clock and/or the like), ephemeris data, almanac data, inertial measurement data (e.g., acceleration, angular rate, and/or the like), and/or range data (e.g., a distance between central satellite(s) 110, distribution satellite(s) 120, a spacecraft 130, and/or ground stations(s) 140). As an illustrative example, navigation data can include ephemeris data (e.g., historical, present, and/or predicted orbital dynamics, trajectory calculations, and/or the like) for distribution satellite(s) 120. Optionally and/or additionally, the communication scheduler 172 may retrieve operational data for the distribution satellite(s) 120, from data store 142 and/or memory 112, 122, and/or the like.

After the communication scheduler 172 retrieves navigation data, the communication scheduler may analyze the navigation data at (3). Analyzing navigation data may be a computationally intensive task as ephemeris data and/or other navigation data for a network of distribution satellite(s) 120 must be synthesized. For example, a communication scheduler 172 may determine a window of availability for communication with distribution satellite(s) 120 (e.g., whether distribution satellite(s) 120 are eclipsed by a celestial body 150, 160), estimate power requirements for communicating with distribution satellite(s) 120, calculate an estimated drift for one or more clocks 124, and/or determine whether distribution satellite(s) 120 are functionally available and able to accept a signal.

Additionally and/or alternatively, a communication scheduler 172 may utilize PNT unit 119, controller 111, power management unit 260, calibration unit 252, and/or signal processor 258 to analyze all and/or a portion of navigation data for central satellite(s) 110 and/or distribution satellite(s) 120. As an illustrative example, a communication scheduler 172 may analyze navigation data by requesting that the PNT unit 119 determine a window of availability for communication with distribution satellite(s) 120 (e.g., whether distribution satellite(s) 120 are eclipsed by a celestial body 150, 160), request that the power management unit 260 estimate power requirements for communicating with distribution satellite(s) 120, request that the calibration unit 252 calculate an estimated drift for one or more clocks 124, and/or request that a controller 111 determine whether distribution satellite(s) 120 are functionally available and able to accept instructions.

After navigation data is analyzed by the communication scheduler 172, the communication scheduler 172 may determine a communication schedule for the distribution satellite(s) 120 at (4). The communication schedule may be optimized to efficiently communicate with distribution satellite(s) 120, by organizing an order for communicating based on navigation data, operational data, power requirements, clock drift, and/or distribution satellite(s) 120 availability as described herein.

Once the communication scheduler 172 determines a communication schedule for the distribution satellite(s) 120, the communication scheduler 172 may transmit the communication schedule and the request to synchronize to the data generator 174 at (5).

Once the communication scheduler 172 transmits the communication schedule and the request to synchronize, the data generator 174 may retrieve the precise clock signal from a precise clock 114 at (6). As described above, a precise clock 114 may be a cesium atomic clock, rubidium atomic clock, hydrogen master clocks, optical atomic clock and/or the like. The precise clock 114 may be used by one or more components of a central satellite 110 for navigation, position information, communication, and/or telemetry data, and/or as a time reference for one or more components of an operating environment 200 of FIG. 2. In some examples, a precise clock signal may be adjusted by a calibration unit 252. A calibration unit 252 may be a control circuit configured to measure and correct the small amounts of clock drift occurring in an atomic clock. In some examples, a calibration unit 252 may measure one or more environmental effects that may cause a precise clock 114 to drift, such as for example, temperature, pressure, gravitation effects, and/or other environmental factors and generate an error calculation and/or correction algorithm to compensate for drift. A calibration unit 252 may include a feedback loop to continuously monitor and correct a precise clock 114 to ensure that a central satellite 110 may generate an accurate and precise clock signal for distribution satellite(s) 120. In some examples, a calibration unit 252 may compare a time signal generated from a precise clock 114 with a time signal received from ground station(s) 140 and/or another central satellite 110 to ensure the accuracy of a precise clock 114. Additionally and/or alternatively, the data generator 174 may retrieve a precise clock signal from ground station(s) 140 and/or central satellite(s) 110.

After retrieving a precise clock signal, the data generator 174 can generate instructions to align an antenna with the distribution satellite(s) 120 based on the communication schedule at (7). For example, the data generator 174 may generate instructions to energize, modulate or demodulate, transmit, and/or the like, one or more components of an enhanced antenna 115 (e.g., gimbal or other antenna steering device 254, aux antenna 256, signal processor 258, and/or another component of central satellite(s) 110). As an illustrative example, the data generator 174 may generate instructions to move a gimbal or other antenna steering device 254 to precisely point an enhanced antenna 115 at a target (e.g., distribution satellite(s) 120, spacecraft 130, ground station(s) 140, and/or the like), generate instructions for a power management unit 260 to supply sufficient energy to an enhanced antenna 115 during transmissions, generate instructions for a signal processor 258 to modulate and/or demodulate one or more signals (e.g., a precise clock signal, instructions to synchronize, and/or the like). In some cases, a data generator 174 may generate instructions to align an enhanced antenna 115 to distribution satellite(s) 120 in a round robin fashion. The data generator 174 may instruct an enhanced antenna 115 to align to a first distribution satellite 120, then to a second distribution satellite 120, and so on. Advantageously, a data generator 174 may generate instructions to align an antenna 115 based an optimal communication schedule as determined by the communication scheduler 172, to periodically provide a precise clock signal to distribution satellite(s) 120.

Additionally and/or alternatively, data generator 174 may generate instructions for an aux antenna 256 to communicate with distribution satellite(s) 120. For example, data generator 174 may determine, based on a communication schedule, that communication with distribution satellite(s) 120 may be achieved by utilizing a lower-powered aux antenna 256 (e.g., distribution satellite(s) 120 are in close proximity to central satellite(s) 110 and/or the like).

Once the data generator 174 generates instructions to align an antenna with the distribution satellite(s) 120, the data generator may generate instructions to synchronize a clock 124 of distribution satellite(s) 120 to a precise clock signal at (8). The instructions to synchronize may instruct distribution satellite(s) 120 (e.g., controller 121) to synchronize clock 124 to a precise clock signal. Additionally and/or optionally, the instructions to synchronize may include a request for the distribution satellite(s) 120 to transmit operational data, navigation data, and/or the like, to central satellite(s) 110. As described above, operational data may include any information associated with one or more functions and/or a status of a central satellite 110, distribution satellite(s) 120, a spacecraft 130, and/or ground station(s) 140. For example, operational data may include, but is not limited to, telemetry data (e.g., a voltage, temperature, pressure, and/or the like), position data, speed, a health status of one or more components, power consumption data, propulsion system data (e.g., fuel remaining, fuel consumed and/or the like), payload instrument data, communication link status, thermal control system status and/or any other property of a component and/or system associated with a device or the environment with which the device operates. As an illustrative example, the request for operational data may include a request to provide an estimated error associated with a clock 124, an estimation of energy consumed and/or remaining in distribution satellite(s) 120, data from sensor(s) 127, and/or the like.

After the data generator generates instructions to synchronize a clock 124 of the distribution satellite(s) 120 to the precise clock signal, the data generator 174 may transmit the precise clock signal, the instructions to align, and/or the instructions to synchronize to the enhanced antenna 115 at (9).

The enhanced antenna 115 may align to the distribution satellite(s) 120 at (10). As part of alignment, the enhanced antenna 115 may energize a gimbal or other antenna steering device 254 to point toward a first distribution satellite 120, modulate and/or demodulate a transmission (e.g., a precise clock signal, instructions to synchronize, and/or the like), and/or emit a signal from the enhanced antenna 115 in accordance with a communication schedule, to enable communication with distribution satellite(s) 120 across vast distances. Advantageously, the enhanced antenna 115 may be utilized to enable communication with an antenna unit 125 of distribution satellite(s) 120. As described herein, the antenna unit 125 may be compact, lighter, simple, and more energy efficient than an enhanced antenna 115. For example, an antenna unit 125 may be a lower powered omni-directional antenna providing coverage in multiple directions. Thus, an antenna unit 125 may have weak reception, which in turn requires a stronger signal emitted by an enhanced antenna 115 to facilitate communication between distribution satellite(s) 120 and central satellite(s) 110.

Once the enhanced antenna 115 aligns to the distribution satellite(s) 120, the enhanced antenna 115 may transmit the precise clock signal and/or the instructions to synchronize to the distribution satellite(s) 120 at (11). Distribution satellite(s) 120 can receive one or more instructions to synchronize a clock 124 (e.g., via controller 121, communication unit 123, antenna unit 125, and/or the like) from the enhanced antenna 115. In response to synchronizing a clock 124, distribution satellite(s) 120 may, for example, maneuver to correct an orbit and/or change an orbit, transmit data from sensor(s) 127, relay data, generate a distress signal and/or another signal, calculate an error associated with an orbit, and/or perform any number of operations associate with a satellite communication network. Additionally and/or alternatively, the precise clock signal and/or the instructions to synchronize may be transmitted to a spacecraft 130, ground station(s) 140, and/or central satellite(s) 110 as described herein.

### Example Aspects Related to a Distribution Satellite Integration Routine

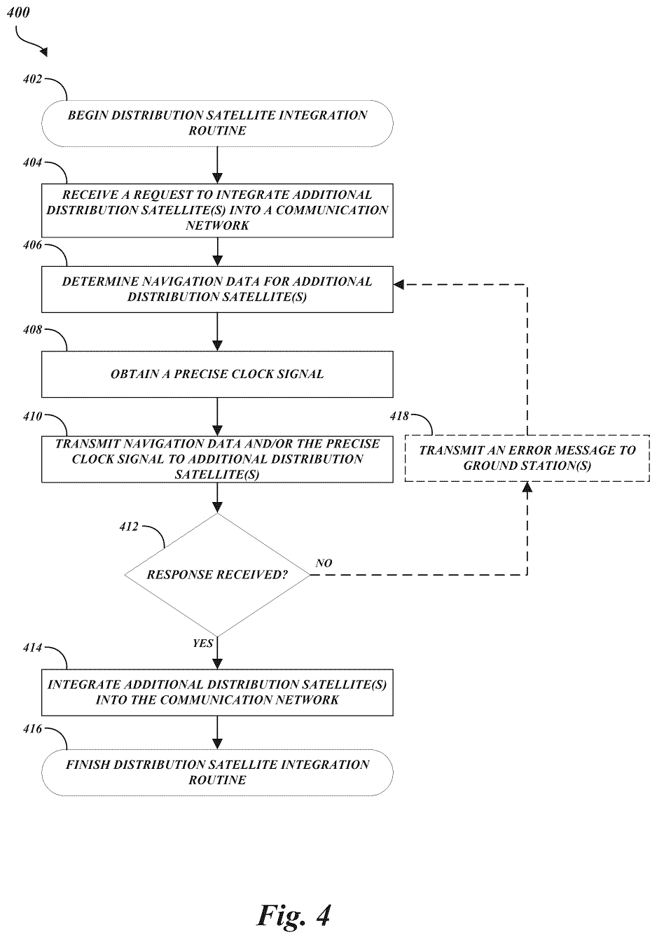

FIG. 4 is an example flow chart of a distribution satellite integration routine 400 illustratively implemented by a central satellite 110 according to one embodiment. As an example, the central satellite 110 of FIG. 2 (e.g., controller 111) can be configured to execute the distribution satellite integration routine 400. The distribution satellite integration routine 400 begins at block 402.

At block 404, the controller 111 can receive a request to integrate additional distribution satellite(s) 120A into a communication network. A request may be received from central satellite(s) 110, distribution satellite(s) 120, a spacecraft 130, and/or ground station(s) 140. Additionally, a request may be generated by the controller 111. The controller 111 may receive a request to integrate an additional distribution satellite 120A in response to, for example, an additional distribution satellite 120A being deployed from payload 118 of central satellite(s) 110.

At block 406, the controller 111 can determine navigation data for the additional distribution satellite 120A. Navigation data can include, but is not limited to, historical, present, and/or predicted attitude data, orientation data, position data, orbital parameters, time synchronization data, ephemeris data, almanac data, inertial measurement data, and/or range data as described herein. As an illustrative example, a controller 111 can determine predicted ephemeris data for additional distribution satellite(s) 120A, to determine an orbit and/or trajectory of the additional distribution satellite(s) 120A in anticipation for communication with the additional distribution satellite(s) 120A. Additionally and/or optionally, navigation data may be retrieved from, for example, data store 142, and/or memory 112, 122 as described herein.

At block 408, the controller 111 obtains a precise clock signal. A controller 111 may receive a precise clock signal from a precise clock 114. The precise clock signal may be a highly accurate and stable timing reference. The precise clock 114 may be used for determining navigation, position information, communication, telemetry data, and/or as a timing reference for one or more components of an operating environment 200. A precise clock 114 may have a minimal amount of drift, due in part to temperature variations, gravitational effects, and/or other environmental factors in comparison to clocks 124 used in additional distribution satellite(s) 120A.

At block 410, the controller 111 transmits navigation data and/or the precise clock signal to the additional distribution satellite(s) 120A. A controller 111 may transmit navigation data and/or a precise clock signal to enable additional distribution satellite(s) 120A to synchronize an onboard clock 124, such that additional distribution satellite(s) 120A may coordinate communications, execute one or more maneuvers, correct a trajectory to maintain an orbit, and/or generate operational data. Additionally and/or alternatively, the controller 111 may transmit operational data and/or a request for distribution satellite(s) 120A to transmit operational data.

Furthermore, the controller 111 may transmit navigation data and/or the precise clock signal via an enhanced antenna 115. An enhanced antenna 115 can be for example, directional antenna and/or another type of antenna, enabling precise alignment and signal strength for optimal communication with distribution satellite(s) 120, spacecraft 130, ground station(s) 140, and/or another central satellite 110. An enhanced antenna 115 may be physically larger, have a higher gain, and achieve a higher signal strength to facilitate longer range communication in comparison to, for example, an antenna unit 125 as part of distribution satellite(s) 120. The enhanced antenna 115 may include one or more components such as a gimbal or other antenna steering device 254, an aux antenna 256, and/or a signal processor 258, to facilitate long range communication, improved network reliability, and/or efficient communication in an operating environment 200 as described herein.

At decision node 412, the controller 111 determines whether a response is received from the additional distribution satellite(s) 120A. If the controller 111 receives a response from the additional distribution satellite(s) 120A, then the routine 400 may continue to block 414. The controller 111 may receive a response from additional distribution satellite(s) 120A indicating that the additional distribution satellite(s) 120 received navigation data and/or the precise clock signal. In some examples, the controller 111 may receive a response from different additional distribution satellite(s) 120, central satellite(s) 110, a spacecraft 130, and/or ground station(s) 140 (e.g., one or more components of an operating environment 200 may relay a response from another component to the controller 111).

Optionally, if the controller 111 determines that a response was not received from the additional distribution satellite 120A and/or another component of an operating environment 200, then the routine 400 may continue to block 418.

Optionally, at block 418 the controller 111 may transmit an error message to ground station(s) 140. Additionally and/or alternatively, the controller 111 may transmit an error message to another component of an operating environment 200 of FIG. 2 (e.g., central satellite(s) 110, distribution satellite(s) 120, and/or a spacecraft 130). The error message may include information relating to navigation data, operational data, and/or a precise clock signal intended for additional distribution satellite(s) 120A. In some examples, a controller 111 and/or ground station(s) 140 may receive and/or determine a corrective action based on an error message. Corrective actions may include, but are not limited to, correcting a precise clock signal, estimating navigation data, attempting to retransmit data to additional distribution satellite(s) 120A, and/or generating operational data associated with a central satellite 110 or additional distribution satellite(s) 120A (e.g., an entry in a historical database such as data store 142, and/or the like). After the controller 111 transmits an error message, the routine 400 may loop back to block 406, where the controller 111 determines navigation data for additional distribution satellite(s) 120A. The controller 111 may loop back to block 406 and/or another block of routine 400 based on a corrective action determined by the controller 111 (e.g., incorrect and/or incomplete navigation data, and/or the like). Additionally and/or optionally, the routine 400 may end after the controller 111 transmits an error message to ground station(s) 140.

At block 414, the controller 111 integrates additional distribution satellite(s) 120A into the communication network. A controller 111 may integrate additional distribution satellite(s) 120A into a communication network by generating and/or updating an optimized communication schedule via communication scheduler 172. The controller 111 (e.g., via communication scheduler 172) may determine an optimized communication schedule for distribution satellite(s) 120 based on several considerations, such as the availability of line-of-sight, time since last transmission and/or last synchronization, operational windows (e.g., whether distribution satellite(s) 120 are operational and/or capable of receiving data), energy consumption (e.g., determining when to point an enhanced antenna 115 and communicate with distribution satellite(s) 120 to reduce energy consumption), predicted satellite communications, and/or the existence of mission critical events (e.g., launch, landing, transfer from one orbit to another, and/or the like). Once the controller 111 integrates additional distribution satellite(s) 120A into the communication network the routine 400 ends at block 416.

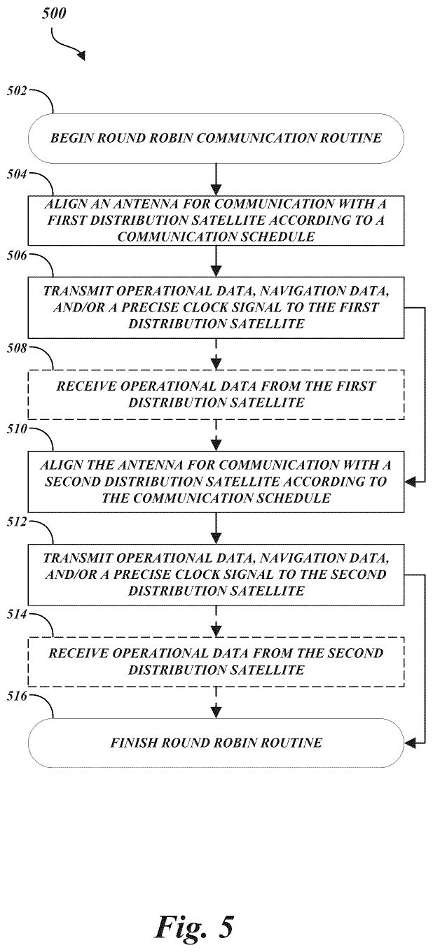

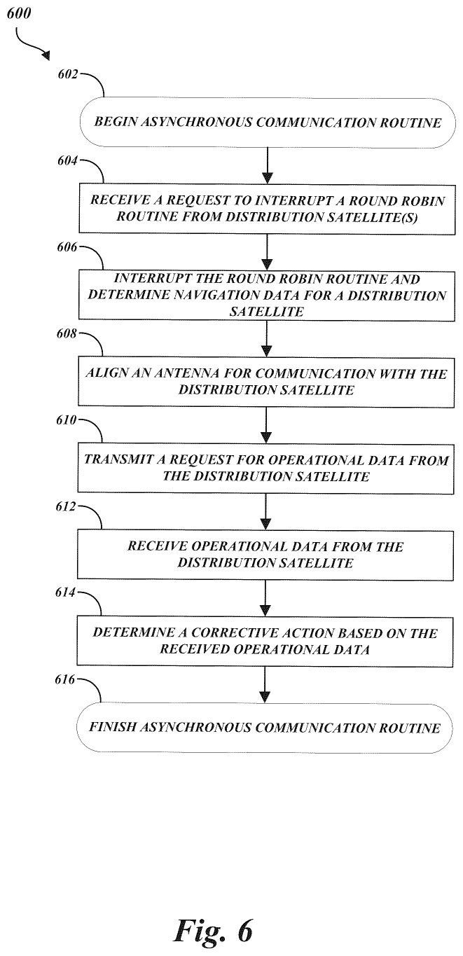

Additionally and/or optionally, after a controller 111 integrates the additional distribution satellite(s) 120A into the communication network, the controller 111 may communicate with distribution satellite(s) 120 in a round robin fashion as described with reference to FIG. 5 and/or asynchronously as described with reference to FIG. 6.

The routine 400 is described with reference to distribution satellite(s) 120, however, controller 111 may integrate spacecraft 130, ground station(s) 140, and/or central satellite(s) 110 in place of and/or along with distribution satellite(s) 120. For example, a controller 111 may integrate two distribution satellite(s) 120, three spacecraft 130, one ground station 140, and/or any combination and/or number of components of an operating environment 200 of FIG. 2.

### Example Aspects Related to a Round Robin Routine

FIG. 5 is an example flow chart of a round robin routine 500 illustratively implemented by a central satellite 110 according to one embodiment. As an example, the central satellite 110 of FIG. 2 (e.g., controller 111) can be configured to execute the round robin routine 500. The round robin routine 500 begins at block 502.

At block 504, the controller 111 can align an antenna for communication with a first distribution satellite 120 according to a communication schedule. A controller 111 may align an enhanced antenna 115 in accordance with a determined communication schedule, as described with reference to block 414 of routine 400. A controller 111 may energize one or more components of an enhanced antenna 115, such as a gimbal or other antenna steering device 254, aux antenna 256, signal processor 258, and/or other components of central satellite(s) 110. As an illustrative example, the controller 111 may generate instructions to enable a gimbal or other antenna steering device 254 to precisely point an enhanced antenna 115 at a first distribution satellite 120. Additionally and/or alternatively, the controller 111 may instruct a gimbal or other antenna steering device 254 to precisely point an enhanced antenna 115 at a spacecraft 130, ground station(s) 140, central satellite 110 and/or the like. The controller 111 may also generate instructions for a power management unit 260 to supply sufficient energy to an enhanced antenna 115 during transmissions, and/or generate instructions for a signal processor 258 to modulate and/or demodulate one or more signals (e.g., a precise clock signal, instructions to synchronize, and/or the like).

At block 506, the controller 111 transmits operational data, navigation data, and/or a precise clock signal to the first distribution satellite 120. A controller 111 may transmit operational data, navigation data and/or a precise clock signal to maintain a satellite communication network, maintain connectivity, and/or any other function associated with a mission's objectives. As an illustrative example, controller 111 may transmit a request for information from sensor(s) 127, a request to synchronize an onboard clock 124, an instruction for distribution satellite(s) 120 to execute one or more maneuvers (e.g., to correct a trajectory, maintain an orbit, and/or transmit operational data as descried herein), a request to relay information from sensor(s) 127 (e.g., temperature data, images of the surface of a celestial body 150, 160, and/or any other sensor information as described herein) to a spacecraft 130 to support a mission's success, and/or the like. The routine 500 may optionally continue to block 508 and/or continue to block 510.

Optionally at block 508, the controller 111 may receive operational data from the first distribution satellite 120. The controller 111 may, based on the operational data received from the first distribution satellite 120, execute a number of operations as described herein, such as relay information to central satellite(s) 110, distribution satellite(s) 120, a spacecraft 130, and/or ground station(s) 140. Store information in memory 112 and/or data store 142, adjust an orbital trajectory calculation for distribution satellite(s) 120, and/or the like.

At block 510, the controller 111 may align the antenna for communication with a second distribution satellite 120 according to the communication schedule. Similar to step (10) of FIG. 3, block 414 of routine 400, and/or block 504, the controller 111 may align an enhanced antenna 115 towards a second distribution satellite 120 in accordance with a determined communication schedule.

At block 512, the controller 111 may transmit operational data, navigation data, and/or a precise clock signal to the second distribution satellite 120 similar to block 506. The routine 500 may optionally continue to block 514 and/or the routine 500 may end at block 516.

Optionally at block 514, the controller 111 may receive operational data from the second distribution satellite 120 similar to block 508. Once the controller 111 receives operational data from the first distribution satellite 120, the routine 500 ends. The routine 500 may repeat blocks 504, 506, 508, 510, 512, and/or 514 depending on the number of distribution satellite(s) 120 associated with a satellite communication network.

The routine 500 is described with reference to a round robin communication scheme for distribution satellite(s) 120, however, controller 111 may communicate with any number of spacecraft 130, ground station(s) 140, and/or central satellite(s) 110 in place of and/or along with distribution satellite(s) 120 as determined by an optimized communication schedule. As an illustrative example, a controller 111 may communicate, via a robin routine 500, with a distribution satellite 120, then a spacecraft 130, then a second distribution satellite 120, then ground station(s) 140, then a second ground station 140, and so on.

### Example Aspects Related to an Asynchronous Communication Routine

FIG. 6 is an example flow chart of an asynchronous communication routine 600 illustratively implemented by a central satellite 110 according to one embodiment. As an example, the central satellite 110 of FIG. 2 (e.g., controller 111) can be configured to execute the asynchronous communication routine 600. The asynchronous communication routine 600 begins at block 602.

At block 604, the controller 111 receives a request to interrupt (e.g., a distress signal, another signal that indicates a request for prioritized communication, a request to pause a communication schedule, etc.) a round robin routine 500 from distribution satellite(s) 120. A request to interrupt may be a low-powered signal providing telemetry data and/or a status of one or more components of an operating environment 200 (e.g., that a fault has occurred, and/or the like). A controller 111 may receive a request to interrupt from an enhanced antenna 115 and/or an aux antenna 256. Additionally and/or optionally, a controller 111 may receive a request to interrupt from another component of an operating environment 200 (e.g., central satellite(s) 110, a spacecraft 130, ground station(s) 140, and/or the like).

At block 606, the controller 111 may interrupt the round robin routine 500 and determine navigation data for the distribution satellite 120. In some cases, the controller 111 may determine navigation data for the distribution satellite 120 based on a received request to interrupt the round robin routine 500. In some cases, the request to interrupt may include navigation data and/or operational data. Additionally and/or alternatively, a controller 111 may receive navigation data from ground station(s) 140 (e.g., via data store 142).

At block 608, the controller 111 can align an antenna for communication with the distribution satellite 120. A controller 111 may align an enhanced antenna for communication with distribution satellite(s) 120, as described with reference to step (10) of FIG. 3, and/or blocks 504, 510 of routine 500.

At block 610, the controller 111 may transmit a request for operational data from the distribution satellite 120. A request for operational data may include, among other things, telemetry data associated with a fault, an estimated clock 124 error, and/or any other data associated with determining a corrective action based on a distress signal and/or another signal that indicates a request for prioritized communication. Optionally, the controller 111 may instruct another component of an operating environment 200 to request operational data and/or navigation data from the distribution satellite 120 (e.g., distribution satellite(s) 120, a spacecraft 130, and/or central satellite(s) 110).

At block 612, the controller 111 may receive operational data from the distribution satellite 120. A controller 111 may receive operational data from the distribution satellite 120 as described with reference to block 508 and/or 514 of routine 500.

At block 614, the controller 111 may determine a corrective action based on the received operational data. A corrective action may include, but is not limited to: transmitting an error message to ground station(s) 140 as described with reference to block 418 of routine 400; removing distribution satellite(s) 120 from a communication network; abandoning distribution satellite(s) 120; transmitting a precise clock signal and a request to synchronize to distribution satellite(s) 120; instructing distribution satellite(s) 120 to change an orbit and/or perform a maneuver; and/or transmit data to central satellite(s) 110, distribution satellite(s) 120, spacecraft 130, and/or ground station(s) 140. Once the controller 111 determines a corrective action based on the received operational data, the routine 600 ends at block 616.

Once the routine 600 ends, the controller 111 may continue execution of a round robin routine 500 by communicating with the next distribution satellite 120 in the round robin routine 500. As an illustrative example, the controller 111 may communicate with a number of distribution satellite(s) 120 in the following order: 1, 2, 3, 4, distress signal and/or another signal received from 2, stop the round robin routine 500, communicate with 2 via asynchronous communication routine 600, then continue a round robin routine 500 at 5, 6, 7, and so on.

Additionally and/or optionally, the controller 111 may skip communications with distribution satellite(s) 120 in a communication schedule when a distress signal and/or another signal requesting prioritized communication interrupts a round robin routine 500. As an illustrative example, the controller 111 may communicate in the following order: 1, 2, 3, distress signal and/or another signal, received from 8, stop the round robin routine 500, communicate with 8 via asynchronous communication routine 600, then continue the round robin routine 500 at 9, 10, and so on.

A controller 111 may adjust and/or change a communication schedule based on a distress signal and/or another signal that indicates a request for prioritized communication. As an illustrative example, the controller 111 may communicate with a number of distribution satellite(s) 120 in the following order: 1, 2, 3, 1, 2, 3, 1, distress signal and/or another signal received from 3, stop the round robin routine 500, communicate with 3 via asynchronous communication routine 600, determine a new communication schedule as described with reference to blocks 406, 408, 410, and/or 414 of routine 400, then execute a round robin routine 500 at 2, 3, 1, 2, 3, 1 and so on.

The routine 600 is described with reference to distribution satellite(s) 120, however, controller 111 may asynchronously communicate with a spacecraft 130, ground station(s) 140, and/or central satellite(s) 110 in response to a distress signal and/or another signal requesting prioritized communication received from one or more components of an operating environment 200 of FIG. 2. As an illustrative example, a controller 111 may asynchronously communicate with ground station(s) 140 in response to receiving a distress signal and/or another signal requesting prioritized communication from a spacecraft 130.

### Terminology

Controllers, such as 111 and/or 121, may be a whole or part of a computer device or system configured to implement a method, process, function, or operation of at least some of the embodiments described herein. For example, a system or methods may be implemented in the form of an apparatus that includes a processing element and a set of executable instructions. The executable instructions may be part of a software application and arranged into a software architecture.

In general, an embodiment may be implemented using a set of software instructions that are designed to be executed by a suitably programmed processing element (such as a GPU, CPU, microprocessor, processor, controller, computing device, etc.). Such instructions may be arranged into “modules” (e.g., “units”, “components”, and/or the like) with each such module typically performing a specific task, process, function, or operation. For example, one module may control central satellite(s) 110, and another module may operate distribution satellite(s) 120. A set of modules may be controlled or coordinated in their operation by an operating system (OS) or other form of organizational platform.

Each application module or sub-module may correspond to a particular function, method, process, or operation that is implemented by execution of the instructions contained in the module or sub-module. Such function, method, process, or operation may include those used to implement one or more aspects, techniques, components, capabilities, steps, or stages of the described system and methods. In some embodiments, a subset of the computer-executable instructions contained in one module may be implemented by a processor in a first apparatus (e.g., central satellite(s) 110), and a second and different subset of the instructions may be implemented by a processor in a second and different apparatus (e.g., managing sensor data read/write operations in distribution satellite(s) 120). This may happen, for example, where a process or function is implemented by steps that occur in both a central satellite 110 and/or distribution satellite(s) 120.

The application modules and/or sub-modules may include any suitable computer executable code or set of instructions (e.g., as would be executed by a suitably programmed processor, microprocessor, or CPU), such as computer-executable code corresponding to a programming language. For example, programming language source code may be compiled into computer-executable code. Alternatively, or in addition, the programming language may be an interpreted programming language such as a scripting language.

The modules may contain one or more sets of instructions for performing a method or function described with reference to FIGS. 1A-1C, 2-6. These modules may include those illustrated but may also include a greater number or fewer number than those illustrated. As mentioned, each module may contain a set of computer-executable instructions. The set of instructions may be executed by a programmed processor contained in central satellite(s) 110 and/or distribution satellite(s) 120, as well as a server, client device, network element, system, platform, or other component. In other words, processors, such as controller 111 and/or controller 121, need not be contained by central satellite(s) 110 and/or distribution satellite(s) 120.

A module may contain computer-executable instructions that are executed by a processor contained in more than one of a server, client device, network element, system, platform, or other component. Thus, in some embodiments, a plurality of electronic processors, with each being part of a separate device, server, platform, or system may be responsible for executing all or a portion of the instructions contained in a specific module.

The foregoing description, for purposes of explanation, used specific nomenclature to provide a thorough understanding of the disclosure. However, it will be apparent to one skilled in the art that the specific details are not required in order to practice the systems and methods described herein. The foregoing descriptions of specific embodiments or examples are presented by way of examples for purposes of illustration and description. They are not intended to be exhaustive of or to limit this disclosure to the precise forms described. Many modifications and variations are possible in view of the above teachings. The embodiments or examples are shown and described in order to best explain the principles of this disclosure and practical applications, to thereby enable others skilled in the art to best utilize this disclosure and various embodiments or examples with various modifications as are suited to the particular use contemplated. It is intended that the scope of this disclosure be defined by the following claims and their equivalents.

As described above, in various implementations certain functionality may be accessible by a user through a web-based viewer (such as a web browser), or other suitable software program). In such implementations, the user interface may be generated by a server computing system and transmitted to a web browser of the user (e.g., running on the user's computing system). Alternatively, data (e.g., user interface data) necessary for generating the user interface may be provided by the server computing system to the browser, where the user interface may be generated (e.g., the user interface data may be executed by a browser accessing a web service and may be configured to render the user interfaces based on the user interface data). The user may then interact with the user interface through the web-browser. User interfaces of certain implementations may be accessible through one or more dedicated software applications. In certain implementations, one or more of the computing devices and/or systems of the disclosure may include mobile computing devices, and user interfaces may be accessible through such mobile computing devices (for example, smartphones and/or tablets).

Many variations and modifications may be made to the above-described implementations, the elements of which are to be understood as being among other acceptable examples. All such modifications and variations are intended to be included herein within the scope of this disclosure. The foregoing description details certain implementations. It will be appreciated, however, that no matter how detailed the foregoing appears in text, the systems and methods can be practiced in many ways. As is also stated above, it should be noted that the use of particular terminology when describing certain features or aspects of the systems and methods should not be taken to imply that the terminology is being re-defined herein to be restricted to including any specific characteristics of the features or aspects of the systems and methods with which that terminology is associated.

Conditional language, such as, among others, “can,” “could,” “might,” or “may,” unless specifically stated otherwise, or otherwise understood within the context as used, is generally intended to convey that certain implementations include, while other implementations do not include, certain features, elements, and/or steps. Thus, such conditional language is not generally intended to imply that features, elements and/or steps are in any way required for one or more implementations or that one or more implementations necessarily include logic for deciding, with or without user input or prompting, whether these features, elements and/or steps are included or are to be performed in any particular implementation.

The term “substantially” when used in conjunction with the term “real-time” forms a phrase that will be readily understood by a person of ordinary skill in the art. For example, it is readily understood that such language will include speeds in which no or little delay or waiting is discernible, or where such delay is sufficiently short so as not to be disruptive, irritating, or otherwise vexing to a user.

Conjunctive language such as the phrase “at least one of X, Y, and Z,” or “at least one of X, Y, or Z,” unless specifically stated otherwise, is to be understood with the context as used in general to convey that an item, term, and/or the like may be either X, Y, or Z, or a combination thereof. For example, the term “or” is used in its inclusive sense (and not in its exclusive sense) so that when used, for example, to connect a list of elements, the term “or” means one, some, or all of the elements in the list. Thus, such conjunctive language is not generally intended to imply that certain implementations require at least one of X, at least one of Y, and at least one of Z to each be present.

The term “a” as used herein should be given an inclusive rather than exclusive interpretation. For example, unless specifically noted, the term “a” should not be understood to mean “exactly one” or “one and only one”; instead, the term “a” means “one or more” or “at least one,” whether used in the claims or elsewhere in the specification and regardless of uses of quantifiers such as “at least one,” “one or more,” or “a plurality” elsewhere in the claims or specification.

The term “comprising” as used herein should be given an inclusive rather than exclusive interpretation. For example, a general-purpose computer comprising one or more processors should not be interpreted as excluding other computer components, and may possibly include such components as memory, input/output devices, and/or network interfaces, among others.

While the above detailed description has shown, described, and pointed out novel features as applied to various implementations, it may be understood that various omissions, substitutions, and changes in the form and details of the devices or processes illustrated may be made without departing from the spirit of the disclosure. As may be recognized, certain implementations of the inventions described herein may be embodied within a form that does not provide all of the features and benefits set forth herein, as some features may be used or practiced separately from others. The scope of certain inventions disclosed herein is indicated by the appended claims rather than by the foregoing description. All changes which come within the meaning and range of equivalency of the claims are to be embraced within their scope.

What is claimed:

1. A device for establishing a satellite communication network, the device comprising:
an antenna configured to communicate with a plurality of satellites;
a clock configured to maintain a stable timing reference for the device;
memory that stores computer-executable instructions; and
a processor in communication with the memory, wherein the computer-executable instructions, when executed by the processor, cause the processor to:
process a request to integrate a first satellite in the plurality of satellites into the satellite communication network;
in response to the request to integrate, retrieve navigation data for the device and the first satellite and a clock signal from the clock;
determine a position of the first satellite relative to the device based on the clock signal and the navigation data;
generate an instruction to synchronize a second clock of the first satellite based on the clock signal;
align the antenna for communication with the first satellite based on the position of the first satellite relative to the device; and
transmit the navigation data, the instruction to synchronize, and the clock signal to the first satellite.

2. The device of claim 1, wherein the clock is at least one of a cesium atomic clock, a rubidium atomic clock, a hydrogen master clock, or an optical atomic clock.

3. The device of claim 1, wherein the navigation data includes ephemeris data, almanac data, inertial measurement data, or range data for the device, the first satellite, and the plurality of satellites.

4. The device of claim 1, wherein the computer-executable instructions, when executed, further cause the processor to:
transmit a request to relay the navigation data, the instruction to synchronize, and the clock signal to the first satellite.

5. The device of claim 1, wherein the computer-executable instructions, when executed, further cause the processor to:
process a request to determine a communication schedule for transmitting the navigation data, the instruction to synchronize, and the clock signal to the first satellite and to the plurality of satellites;
retrieve navigation data for the plurality of satellites;
determine a communication schedule for the first satellite and the plurality of satellites based on the navigation data for the device, the first satellite, and the plurality of satellites, and the clock signal, wherein the communication schedule assigns a priority and an interval for communicating with the first satellite and the plurality of satellites;
generate an instruction to synchronize the clock of the first satellite and one or more clocks of the plurality of satellites according to the clock signal;
align the antenna for communication with the first satellite and the plurality of satellites according to the communication schedule; and
transmit the navigation data, the instruction to synchronize, and the clock signal to the first satellite and the plurality of satellites.

6. The device of claim 5, wherein the computer-executable instructions, when executed, further cause the processor to:
process a request to interrupt the communication schedule and prioritize communication with a second satellite;
cause the device to pause communication with the plurality of satellites;
determine, based on the processed request, an estimated position of the second satellite;
align the antenna for communication with the second satellite; and
transmit the navigation data, the instruction to synchronize, and the clock signal to the second satellite.

7. The device of claim 6, wherein the computer-executable instructions, when executed, further cause the processor to:
in response to transmitting the navigation data, the instruction to synchronize, and the clock signal to the second satellite, resume communication with the plurality of satellites according to the communication schedule.

8. The device of claim 1, further comprising:
the antenna further comprising:
a gimbal configured to point the antenna in a direction of the plurality of satellites, such that the plurality of satellites can receive a signal without pointing a gimbal; and
a signal processor configured to modulate or demodulate a signal for communication with the plurality of satellites, such that the plurality of satellites may communicate with the device without demodulating or modulating the signal; and
the clock further comprising:
a calibration unit configured to:
determine a clock drift for the clock based on a temperature or a gravitational effect;
calculate a latency associated with at least one electrical circuit, wherein the latency is calculated based on a time between the clock signal at the clock and the clock signal at the antenna; and
modify the clock signal based on the clock drift and the latency.

9. The device of claim 8, wherein the computer-executable instructions, when executed, further cause the processor to:
cause the gimbal to point the antenna towards the first satellite based on the position of the first satellite relative to the device;
cause the calibration unit to adjust the clock signal based on a determined clock drift and a calculated latency such that the plurality of satellites can obtain a precise clock signal; and
instruct the signal processor to modulate or demodulate the navigation data, the instruction to synchronize, and the clock signal such that the first satellite can operate without modulating or demodulating one or more signals.

10. A system for establishing a satellite communication network, the system comprising:
a spacecraft comprising:
an antenna configured to communicate with a plurality of satellites;
a clock configured to maintain a stable timing reference for the spacecraft;
memory that stores computer-executable instructions; and
a processor in communication with the memory, wherein the computer-executable instructions, when executed by the processor, cause the processor to:
process a request to integrate the plurality of satellites into the satellite communication network;
in response to the request to integrate, retrieve navigation data for the spacecraft and the plurality of satellites, and a clock signal from the clock;
determine a position of the plurality of satellites relative to the spacecraft based on the clock signal and the navigation data;
generate an instruction to synchronize an onboard clock of the plurality of satellites according to the clock signal;
align the antenna for communication with the plurality of satellites based on the position of the plurality of satellites relative to the spacecraft; and
transmit the navigation data, the instruction to synchronize, and the clock signal to the plurality of satellites; and
the plurality of satellites configured to transmit and receive communication signals from the spacecraft.

11. The system of claim 10, wherein the clock is at least one of a cesium atomic clock, a rubidium atomic clock, a hydrogen master clock, or an optical atomic clock.

12. The system of claim 10, wherein the navigation data includes ephemeris data, almanac data, inertial measurement data, or range data for the spacecraft and the plurality of satellites.

13. The system of claim 10, wherein the computer-executable instructions, when executed, further cause the processor to:
transmit a request to relay the navigation data, the instruction to synchronize, and the clock signal to at least one other satellite in the plurality of satellites.

14. The system of claim 10, wherein the computer-executable instructions, when executed, further cause the processor to:
process a request to determine a communication schedule for transmitting the navigation data, the instruction to synchronize, and the clock signal to the plurality of satellites;
determine a communication schedule for the plurality of satellites based on the navigation data and the clock signal, wherein the communication schedule assigns a priority and an interval for communications with the plurality of satellites;
generate an instruction to synchronize the onboard clock of the plurality of satellites based on the clock signal;
align the antenna for communication with the plurality of satellites according to the communication schedule; and
transmit the navigation data, the instruction to synchronize, and the clock signal to the plurality of satellites based on the communication schedule.

15. The system of claim 14, wherein the computer-executable instructions, when executed, further cause the processor to:
process a request to interrupt the communication schedule and prioritize communication with at least one satellite in the plurality of satellites;
cause the spacecraft to pause communication with the plurality of satellites;
determine, based on the processed request, an estimated position of the at least one satellite;
align the antenna for communication with the at least one satellite; and
transmit the navigation data, the instruction to synchronize, and the clock signal to the at least one satellite.

16. The system of claim 15, wherein the computer-executable instructions, when executed, further cause the processor to:
in response to transmitting the navigation data, the instruction to synchronize, and the clock signal to the at least one satellite, resume communication with the plurality of satellites according to the communication schedule.

17. The system of claim 10, further comprising:
the antenna further comprising:
a gimbal configured to point the antenna in a direction of the plurality of satellites, such that the plurality of satellites can receive a signal without pointing a gimbal; and
a signal processor configured to modulate or demodulate a signal for communication with the plurality of satellites, such that the plurality of satellites may communicate with the spacecraft without demodulating or modulating the signal; and
the clock further comprising:
a calibration unit configured to:
determine a clock drift for the clock based on a temperature or a gravitational effect;
calculate a latency associated with at least one electrical circuit, wherein the latency is calculated based on a time between the clock signal at the clock and the clock signal at the antenna; and
modify the clock signal based on the clock drift and the latency.

18. The system of claim 17, wherein the computer-executable instructions, when executed, further cause the processor to:
cause the gimbal to point the antenna towards a first satellite in the plurality of satellites based on the position of the spacecraft relative to the first satellite;
cause the calibration unit to adjust the clock signal based on a determined clock drift and a calculated latency such that the plurality of satellites can obtain a precise clock signal; and
instruct the signal processor to modulate or demodulate the navigation data, the instruction to synchronize, and the clock signal such that the first satellite can operate without modulating or demodulating one or more signals.

19. A non-transitory, computer-readable medium comprising computer-executable instructions for establishing a satellite communication network, wherein the computer-executable instructions, when executed by a computer system, cause the computer system to:
process a request to integrate a first satellite into the satellite communication network;
in response to the request to integrate, retrieve navigation data for a spacecraft and the first satellite, and a clock signal from a clock;
determine a position of the first satellite relative to the spacecraft based on the clock signal and the navigation data;
generate an instruction to synchronize a second clock of the first satellite based on the clock signal;
align an antenna for communication with the first satellite based on the position of the first satellite relative to the spacecraft; and
transmit the navigation data, the instruction to synchronize, and the clock signal to the first satellite.

20. The non-transitory, computer-readable medium of claim 19, wherein the computer-executable instructions, when executed, further cause the computer system to:
process a request to determine a communication schedule for transmitting the navigation data, the instruction to synchronize, and the clock signal to the first satellite and to a plurality of satellites;
retrieve navigation data for the plurality of satellites;
determine a communication schedule for the first satellite and the plurality of satellites based on the navigation data for the spacecraft, the first satellite, and the plurality of satellites, and the clock signal, wherein the communication schedule assigns a priority and an interval for communicating with the first satellite and the plurality of satellites;
generate an instruction to synchronize the clock of the first satellite and one or more clocks of the plurality of satellites according to the clock signal;
align the antenna for communication with the first satellite and the plurality of satellites according to the communication schedule; and
transmit the navigation data, the instruction to synchronize, and the clock signal to the first satellite and the plurality of satellites.
